(19) United States
(12) Patent Application Publication
(10) Pub. No.: US 2016/0062587 A1
(43) Pub. Date: Mar. 3, 2016

(54) DYNAMIC BOXING OF GRAPHICAL OBJECTS, IN PARTICULAR FOR KNOWLEDGE QUANTIFICATION

(71) Applicant: Quizista GmbH, Germering (DE)

(72) Inventor: Florian MÜLLER, Germering (DE)

(21) Appl. No.: 14/520,374

(22) Filed: Oct. 22, 2014

Related U.S. Application Data
(63) Continuation-in-part of application No. PCT/EP2014/068059, filed on Aug. 26, 2014.

(51) Int. Cl. G06F 3/0486; G06F 3/0484; G09B 7/02; G06F 3/0488

(52) U.S. Cl. CPC G06F 3/0486; G06F 3/04883; G06F 3/04842; G09B 7/02

(57) ABSTRACT

The present invention relates to a computer-implemented method for processing drag-and-drop gestures on a user interface, the method comprising the steps of displaying a plurality of graphical objects (M0-M8) on the user interface, at least two of said graphical objects (M0-M8) each being associated with a data structure, at least two of said data structures being associated with a model answer of an automated knowledge quantification system, detecting a drag-and-drop gesture on the user interface indicating that a first one of the plurality of graphical objects is moved relative to a second one of the plurality of graphical objects, and dynamically determining that the first and second graphical objects belong to a common group of objects based on the proximity of the first to the second graphical object.

### 1. RELATED APPLICATION

This application is a Continuation-in-Part (CIP) of PCT Patent Application No. PCT/EP2014/068059 filed Aug. 26, 2014, the contents of which are incorporated herein by reference in their entity.

### 2. TECHNICAL FIELD

The present invention generally relates to methods and systems for processing drag-and-drop gestures on a user interface. More specifically, aspects of the present invention provide techniques for a dynamic boxing of graphical objects, which is particularly suitable for use in automated knowledge quantification systems.

### 3. BACKGROUND

Programmable electronic devices are capable of, and frequently used for, automated knowledge assessment, where typically a set of objectively validatable answers to a question can be predefined.

Computer-implemented knowledge assessment is in many aspects superior over knowledge assessment based on human interaction, since it provides among others the advantages described in the following. Computing devices are available to a user 24 hours a day, seven days a week, which leads to an improved availability of correspondingly implemented knowledge assessment techniques. Questions and potentially also accompanying information may be enriched with multimedia, leading to an improved usage. Programmable devices using a hardware and/or software timer are capable of a more precise and objective measurement and limitation of the time which passes between outputting a question and submission of an answer for validation, and of calculating instantly upon receipt of an answer a (multifactorial) score, e.g. taking into consideration a diversity of factors (such as, without limitation, response times, the number of failed attempts, and the difficulty level of a question). Computing devices can select questions based on entirely objective criteria.

Various techniques for computer-aided knowledge assessment are known. For example, EP 2 228 780 A1 and US 2010/227305 A1 relate to a knowledge assessment tool for processing and managing test data, randomly selecting test questions, and storing test results in a database. U.S. Pat. No. 8,465,288 Bi relates to an individual characterization involving an age appropriate ability score, an aptitude score, and an innate and cognizant ability score. U.S. Pat. No. 8,356,997 Bi relates to a competency record comprising a set of data indicating a given student's knowledge in a plurality of competencies. U.S. Pat. No. 6,318,722 Bi relates to a word puzzle game in which dues and answers are hidden and exposed. US 2012/0178073 A1 relates to game systems with interoperating or both interoperating and interrelated quizzes and/or puzzles, whereby the solution to one question represents a clue helping the user in solving part of a subsequent word puzzle. WO 2007/007201 A2 and WO 2006/000632 A2 provide further technical background information about computer-implemented knowledge assessment techniques.

### 4. SUMMARY OF THE INVENTION

One particular disadvantage of many of the known techniques is that the assessment of whether a user knows a given set of facts concerning item relationships is conducted sequentially, i.e., the user is required to answer a series of questions about item relationships one question at a time. For example, the user would be required to separately state the country in which each of a plurality of mountains is located, or to separately answer questions concerning particular predecessors and successors of a political office-holder. Sufficient screen space provided, it is, however, preferable to enable users to modify, by means of repositioning graphical objects on a display, the assignment to a group or ranking of any item (of a plurality of items) at any time prior to collective submission for evaluation of a plurality of choices made.

To the extent that any known techniques, including drag-and-drop technologies from outside the field of knowledge quantification, enable the collective submission of a plurality of choices concerning item relationships, their user interfaces have disadvantages, in connection with knowledge quantification and certain other fields of use, with respect to flexibility (in terms of the user's freedom to place items in arbitrary positions on a work space) and efficiency (in terms of the use of screen resources), as will be described in the following:

One common technique for assigning an item to a group with a drag-and-drop interface is to drag an item over to a container (such as a window) of another group and to drop it within the boundaries of that container. For example, a movable graphical object representing a file can be moved from one folder on a storage medium to another by dragging it from the window displaying the content of one container to the window displaying the content of another container. Similarly, items can also be dropped on target icons such as folder icons.

Drag-and-drop interfaces of the above-mentioned kind are, however, not optimized for the specific needs of such fields as knowledge quantification. For example, a file dropped into a directory folder will disappear from the window on which the operation is performed, requiring a more space-consuming multi-window display to keep track of the content of all containers. This has the further effect that items accidentally dropped in the wrong container can usually not be immediately moved from the wrong container to a different one without previously opening the original target container. However, in certain fields such as knowledge quantification, it is desirable to ensure the simultaneous display of all movable graphical objects and to minimize the number of user interface actions a user must perform to reassign an item to a different group.

For example, the layout section of the user interface of Google's Blogger website (www(dot)blogger(dot)com) enables, through a drag-and-drop interface, the modification of the vertical order in which certain components appear on a web page. Using this interface, the user can pick up an object and place it in a different slot. A further example is LinkedIn (www(dot)linkedin(dot)com), which provides a similar drag-and-drop interface with a two-dimensional (multiple rows, two columns) list of items. A Blogger/LinkedIn-style drag-and-drop interface as described above enables the user to indicate an order of a plurality of items (in this case, a desired order; in connection with knowledge quantification, the order would be a presumed order to be subsequently evaluated for accuracy).

However, such an interface has flexibility and efficiency shortcomings. Each item in such an interface fills the same amount of screen space regardless of the actually-required space. The number of slots in which an item can be placed is identical to the number of items without allowing a more free-form placement of items in different positions. For example, a user of such an interface cannot elect to open a separate line of items because the number of lines is predetermined and static.

It is therefore one technical problem underlying aspects of the present invention to provide methods and systems which enable users to indicate, by means of repositioning graphical objects on a display, the assignment to a group and/or ranking of each of a plurality of items and to modify such choices at any time prior to collective submission for evaluation of a plurality of choices made, while striking a balance between the user's flexibility (in terms of the user's freedom to place items in different positions) and efficiency (in terms of the use of screen resources and processing time), thereby at least partly overcoming the above-mentioned disadvantages. It is another technical problem underlying aspects of the present invention to provide methods and systems capable of interpreting and evaluating the user's positioning of graphical objects in ways that result in an automated yet precise and differentiated quantification of a user's knowledge.

This problem is according to one aspect of the invention solved by a computer-implemented method for processing drag-and-drop gestures on a user interface. In the embodiment of claim 1, the method comprises the following steps:
a. displaying a plurality of graphical objects on the user interface, at least two of said graphical objects each being associated with a data structure, at least two of said data structures being associated with a model answer of an automated knowledge quantification system;
b. detecting a drag-and-drop gesture on the user interface indicating that a first one of the plurality of graphical objects is moved relative to a second one of the plurality of graphical objects; and
c. dynamically determining that the first and second graphical objects belong to a common group of objects based on the proximity of the first to the second graphical object.

Accordingly, the invention incorporates some of the elements found in known drag-and-drop interfaces, including, by way of example and without limitation, movable graphical objects associated with data structures and displayed on a screen or part thereof as well as the detection of gestures representing the actions of picking up, moving, and/or dropping the movable graphical objects, and the repositioning of movable graphical items in response to drag-and-drop gestures.

Certain drag-and-drop gestures have emerged as a de-facto user interface standard. Movable graphical objects are commonly picked up by keeping a (typically the left) mouse button down or a finger on the touchscreen, in each case at least in part within the boundaries of the movable graphical object to be dragged, while moving around; and they are commonly dropped by releasing the mouse button or removing the finger from the touchscreen. The invention is, however, not tied to any particular gesture or set of gestures.

Examples of associated data structures include, by way of example and without limitation, text strings, numbers, images, audio segments, video clips, files, databases, data sets of databases, data sets such as postal addresses and user records, URLs, HTML pages, and XML objects.

The invention builds on such elements of known drag-and-drop interfaces and provides optimizations and functional enhancements, some of which are specific to the field of use of knowledge quantification.

In particular, the invention detects when a user has moved a first graphical object relative to a second graphical object, and dynamically determines that the first and second graphical objects belong to a common group of objects. Importantly, this dynamic determination is according to the invention based on the proximity of the first to the second graphical object.

This way, the invention maximizes the user's freedom to arrange items (movable graphical objects, each of which is associated with a data structure) on a screen or part thereof for the purpose of grouping (preferably followed by operations on the movable graphical objects and/or operations on the associated data structures and/or evaluations of the associated data structures) and simultaneously minimizes the use of limited screen resources by means of a dynamic boxing mechanism. Therefore, the available screen space is used as efficiently as possible, which is particularly advantageous in the context of devices with limited screen space, such as mobile phones or tablets.

The dynamic boxing aspect of the invention departs from traditional container-centric grouping mechanisms (such as windows in which items can be dropped) in that it interprets the user's intent to group items based on the relative proximity of movable graphical objects and dynamically creates or updates one or more boxings, each indicating the boundaries of a proximity-based group of items. Dynamic boxing enables the user to form a flexible number of item groups in arbitrary locations within a work space. Dynamic boxings can have a largely (apart from certain rules) arbitrary shape as opposed to, for example, rectangular windows.

In one aspect of the invention, the proximity-based determination that the first and second graphical objects belong to a common group comprises determining whether the second graphical object at least partially overlaps at least one proximity rectangle around the first graphical object. Using one or more proximity rectangles allows a particularly fast and processing-efficient determination of whether two items belong to the same group, since it avoids complex trigonometric computations of item-to-item distances.

In another aspect of the invention, the step of determining that the first and second graphical objects belong to a common group is performed iteratively for each of the plurality of graphical objects. Such an iterative processing may be implemented by way of example and without limitation by means of recursive function calls, loops, or the like.

Furthermore, the step of dynamically determining that the first and second graphical objects belong to a common group may be based on a predefined required proximity of the first to the second graphical object or on a relative proximity of the first to the second graphical object compared to at least one third graphical object.

Preferably, the method comprises the further step of dynamically displaying a graphical indication of the common group of objects. The graphical indication of the common group of objects may comprise a polygonal shape adapting dynamically to contours of the graphical objects belonging to the group. Using a polygonal shape, the dynamic boxing of the invention has a particularly great screen-space-saving effect, since the boundaries of a group form a polygon that is (unless the items are arranged in a rectangular form) closer to the items than another form of predefined container, such as a rectangular box or window, would be. This way, each group occupies no or only limited screen space beyond the minimum requirement, and leaves a maximum of screen space for other groups.

Such a polygonal group shape can be determined using any of various algorithms existing in computational geometry for computing convex hulls, concave hulls and/or alpha shapes.

Optionally, the method may perform a two-dimensional normalization of all graphical objects belonging to a common group of objects.

In yet another aspect of the invention, the graphical indication of the common group of objects may be calculated by travelling from one vertex of the graphical objects belonging to the group to the next to determine a polygonal shape of the group.

Preferably, the user interface used in embodiments of the present invention is displayed on a touch-sensitive display of a portable electronic device. Accordingly, touch-sensitive screens are the preferred input device for the invention. This is also the input technology in connection with which the invention delivers the greatest relative benefit over known user interfaces. However, the invention is not tied to any particular input technology. Different input technologies enable alternative interfaces that serve similar purposes. For example, user interfaces relying on a mouse as well as a keyboard provide an efficient way to select multiple graphical objects by holding a key (commonly the Shift key) pressed while clicking on each object. The user can then move, assign or manipulate the entire set of selected objects at the same time, in a single operation, which may provide efficiency gains in certain contexts. Multiple-object selection is less efficient on a touchscreen. Therefore, certain alternative user interfaces relying on a mouse and a keyboard may enable users to perform certain operations, in general or in a specific context such as knowledge quantification, with a smaller number of input actions than with the preferred embodiment of the invention, especially if combined with keyboard shortcuts and/or context-sensitive menus. Such alternative user interfaces are, however, structurally different from the invention. All other things being equal, the invention consistently delivers all of its technical benefits.

The present invention is also directed to a computer program comprising instructions for implementing any of the above-described methods.

Furthermore, a portable electronic device is provided comprising a display, preferably a touch-sensitive display, configured for displaying a plurality of graphical objects on a user interface, at least two of said graphical objects each being associated with a data structure, at least two of said data structures being associated with a model answer of an automated knowledge quantification system, and a processor, configured for detecting a drag-and-drop gesture on the user interface indicating that a first one of the plurality of graphical objects is moved relative to a second one of the plurality of graphical objects, and for dynamically determining that the first and second graphical objects belong to a common group of objects based on the proximity of the first to the second graphical object.

Further advantageous modifications of the systems and methods according to embodiments of the present invention are defined in the appended claims.

### 5. BRIEF DESCRIPTION OF THE DRAWINGS

In the following detailed description, presently preferred embodiments of the invention are further described with reference to the following figures:

FIGS. 1-1 and 1-2: Exemplary screen layouts for containerless grouping before and after user interaction in accordance with embodiments of the invention;

FIGS. 2-1 and 2-2: Exemplary screen layouts for combined grouping and sorting without containers before and after user interaction in accordance with embodiments of the invention;

FIG. 3: An exemplary comparison of grouping input against correct grouping in accordance with embodiments of the invention;

FIG. 4: An exemplary differentiated scoring of grouping input in accordance with embodiments of the invention;

FIGS. 5-1, 5-2 and 5-3: Exemplary permutations for categorization of item groups from containerless groups in accordance with embodiments of the invention;

FIG. 6: A flowchart for generating permutations of item groups if user-formed number of groups matches correct number in accordance with embodiments of the invention;

FIG. 7: A flowchart for generating permutations of item groups if user-formed number of groups falls short of correct number in accordance with embodiments of the invention;

FIG. 8: A flowchart for generating insertion patterns each of which must finally be filled with all permutations of item groups if user-formed number of groups exceeds correct number in accordance with embodiments of the invention;

FIG. 9: A flowchart of filling given insertion pattern with given permutation of item groups (scenario: user-formed number of groups exceeds correct number) in accordance with embodiments of the invention;

FIG. 10: An exemplary identification of containerless groups for dynamic boxing with invisible proximity rectangle in accordance with embodiments of the invention;

FIG. 11: An exemplary identification of containerless groups for dynamic boxing; comparison of corner sector of proximity rectangle to quadrant of ellipse in accordance with embodiments of the invention;

FIG. 12: An example of the relative distance of one item to closest items from two other groups in accordance with embodiments of the invention;

FIG. 13: An exemplary optimal distance determination (identification of threshold) in accordance with embodiments of the invention;

FIG. 14: An exemplary comparison of sorting input against correct order with Kendall tau distance in accordance with embodiments of the invention;

FIG. 15: An exemplary comparison of sorting input against correct order with item-by-item distance in accordance with embodiments of the invention;

FIG. 16: An exemplary identification of user-determined one-dimensional (in this example, vertical) order of items (arbitrary item locations) in accordance with embodiments of the invention;

FIG. 17: An exemplary identification of user-determined two-dimensional order of items (arbitrary item locations; identifying rows) in accordance with embodiments of the invention;

FIG. 18: An exemplary visualization of identified user-determined two-dimensional order of items (arbitrary item locations; row lines) in accordance with embodiments of the invention;

FIG. 19: An exemplary convex hull (elastic band) around containerless item group in accordance with embodiments of the invention;

FIG. 20: An exemplary two-dimensional normalization of containerless item group in accordance with embodiments of the invention;

FIG. 21: An example of determining next vertex of dynamic boxing based on nearby items in accordance with embodiments of the invention;

FIG. 22: An exemplary inward straight in accordance with embodiments of the invention;

FIG. 23: An example of determining next vertex of dynamic boxing based on nearby items (with inward straight avoidance zone) in accordance with embodiments of the invention;

FIG. 24: An exemplary inward straight minimized in accordance with embodiments of the invention;

FIG. 25: An example of reducing the number of outward corners by identifying most outward item in given zone (here: inward straight avoidance zone; could also be any other zone) in accordance with embodiments of the invention;

FIG. 26: An exemplary optimization over FIG. 25 through additional identification of closest outward corner in accordance with embodiments of the invention;

FIG. 27: An exemplary diagonal connection to most outward potential vertex (requires analysis of location of other potential vertices relative to diagonal line) in accordance with embodiments of the invention;

FIG. 28: An example of bridging gaps to subsequent vertices I (diagonal lines) in accordance with embodiments of the invention;

FIG. 29: An example of bridging gaps to subsequent vertices II (perpendicular lines) in accordance with embodiments of the invention;

FIG. 30: An example of keeping distance between boxings and items in accordance with embodiments of the invention;

FIG. 31: An example of converting actual vertex into display vertex (X coordinates left to right, Y coordinates top to bottom) in accordance with embodiments of the invention;

FIG. 32: An example of determining next vertex of dynamic boxing based on nearby items (ignore zone and outward-only zone) in accordance with embodiments of the invention;

FIGS. 33-1 and 33-2: Examples of determining pixel coordinates of dynamic boxing zones (direction: down) in accordance with embodiments of the invention;

FIG. 34: An example of determining pixel coordinates of dynamic boxing zones (direction: up) in accordance with embodiments of the invention;

FIG. 35: An example of determining pixel coordinates of dynamic boxing zones (direction: right) in accordance with embodiments of the invention;

FIG. 36: An example of determining pixel coordinates of dynamic boxing zones (direction: left) in accordance with embodiments of the invention;

FIGS. 37-1, 37-2 and 37-3: Flowcharts for searching for subsequent vertex in all zones; inner part of loop (handling a single neighbour item) in accordance with embodiments of the invention;

FIGS. 38-1a, 38-1b, 38-2a, 38-2b, 38-3a, 38-3h, 38-4a and 38-4b: Examples of building subsequent vertices (scenario 1: collinear continuation; originating vertex redundant) in accordance with embodiments of the invention;

FIGS. 39-1, 39-2, 39-3 and 39-4: Examples of building subsequent vertices (scenario 2: inward movement to the least inward item) in accordance with embodiments of the invention;

FIGS. 40-1, 40-2, 40-3 and 40-4: Examples of building subsequent vertices (scenario 3: turning inward in absence of inward and outward item) in accordance with embodiments of the invention;

FIGS. 41-1, 41-2, 41-3 and 41-4: Examples of building subsequent vertices (scenario 4: turning outward to closest outward item) in accordance with embodiments of the invention;

FIGS. 42-1, 42-2, 42-3 and 42-4: Examples of building subsequent vertices (scenario 5: turning outward to non-ward item) in accordance with embodiments of the invention;

FIG. 43: An example of identifying enclave groups through ray casting in accordance with embodiments of the invention; and

FIG. 44: An exemplary hardware layout in accordance with embodiments of the invention.

### 6. DETAILED DESCRIPTION

The present invention may be a device, a system, a method, one or more servers, including servers which are implemented as virtual machines, for brevity may be referred to herein as a server, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform form aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, a module refers to one or more routines, subsystems, and/or the like, whether implemented in hardware, software, firmware or some combination thereof. As would be understood by one of ordinary skill in the art, modules may be configured in many combinations to accomplish the same function. For instance, an example of a software module is any block of code that may be logically grouped together and may or may not use the conventional subroutine interfaces as defined by typical programming languages. A program routine or subroutine is generally understood as a stylistic convention of programming, and thus different routines or subroutines may be written in multiple combinations and accomplish the same function. As used herein, a “module” includes any block of code or programmable processor or chip having a function that may be logically grouped together regardless of whether conventional subroutine interfaces as defined by typical programming languages are used or specific processors or chip configurations are used.

### Overview

Preferred embodiments of the present invention receive, respond to, and evaluate gestures performed by one or more users with or on an input device 10, such as a touch-sensitive screen (cf. FIG. 44), in order to quantify the user's or users' knowledge of certain item relationships, the items being represented as graphical objects. The item relationships include the membership of an item in a particular item group (for example, the fact that a given mountain is located in a particular country), the order of a plurality of items by a given criterion (for example, the order of presidents by first term in office), and combinations thereof. While it would be possible to quantify the user's knowledge by means of a series of related questions (for example, requiring a user to enter or choose the country in which each of a series of given mountains is located, or requiring a user to choose the correct one of several alternative orders of presidents by first term in office), the invention enables users to modify, by means of repositioning graphical objects on a display, the assignment or ranking of any item (of a plurality of items) at any time prior to collective submission for evaluation of the entirety of choices made.

The invention maximizes the user's freedom to arrange items (movable graphical objects, each of which is associated with a data structure) on a screen or part thereof for the purpose of grouping (followed by operations on the movable graphical objects and/or operations on the associated data structures and/or evaluations of the associated data structures) and simultaneously minimizes the use of limited screen resources by means of a dynamic boxing mechanism. The dynamic boxing aspect of the invention departs from traditional container-centric grouping mechanisms (such as windows in which items can be dropped) in that it interprets the user's intent to group items based on the relative proximity of movable graphical objects and dynamically creates or updates one or more boxings, each indicating the boundaries of a proximity-based group of items. Dynamic boxing enables the user to form a flexible number of item groups in arbitrary locations within a work space. Dynamic boxings have a largely (apart from certain rules) arbitrary shape as opposed to, for example, rectangular windows.

Embodiments of the invention are furthermore capable of determining a differentiated score for a set of choices submitted for evaluation, as will be explained in greater detail further below.

In the following, various user interface elements and grouping/boxing techniques employed in embodiments of the invention will be described. It will be appreciated that the present invention concerns various embodiments comprising at least part or all of the below-described concepts.

### Work Spaces and Dynamic Boxings

### Work Space(s)

The movable graphical objects of embodiments of the invention can be displayed on a single work space (such as, by way of example and without limitation, a window) or on a plurality of work spaces. Known drag-and-drop techniques are capable of moving items between work spaces, provided that the work space from which a given item is picked up is capable of dragging and that the work space in which a given item is dropped is capable of being the receiving end of a drag-and-drop operation.

A work space can, but need not, be a contiguous, uninterrupted area. For example, there could be a (typically non-movable) display area inside a work space, and the display area may not accept dropped items.

### Dynamic Boxings

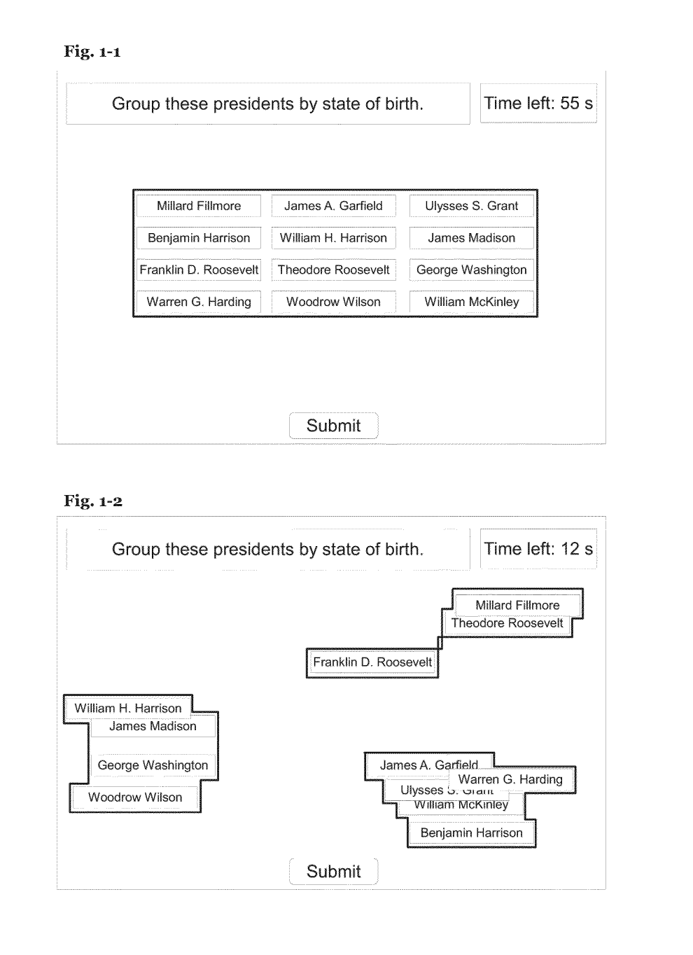

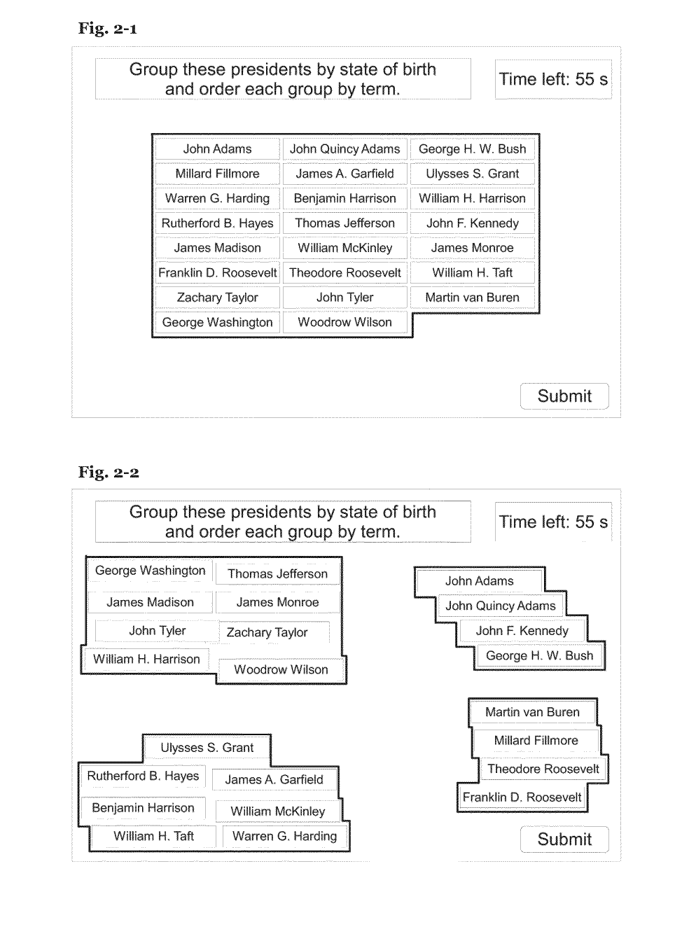

FIG. 1-1 shows an exemplary application of dynamic boxing in connection with knowledge quantification, in which the names of 12 presidents of the United States are displayed in the middle of a work space and surrounded by a graphical hull. The user is requested to group these presidents by state of birth. FIG. 1-2 shows an exemplary screen layout after some user interaction. At this stage the user has formed three groups by repositioning the movable graphical objects: a first group consisting of presidents born in Virginia (William H. Harrison, James Madison, George Washington, and Woodrow Wilson), a second group consisting of presidents born in New York (Millard Fillmore, Theodore Roosevelt, Franklin D. Roosevelt), and a third group consisting of presidents born in Ohio (James A. Garfield, Warren G. Harding, Ulysses S. Grant, William McKinley, Benjamin Harrison). Each of the three groups has its own graphical hull, whereby, in this example and without limitation, the hull of the second group has intersecting lines (between the two Roosevelts).

The dynamic boxing of a group of items is capable of adjusting to each movement of an item that already is or as a result of its repositioning becomes an item of the group. Certain repositionings do not affect the dynamic boxing of a group. By way of example and without limitation, if an item is moved from one position to another, and it is surrounded in either position by other items to the extent that the item never forms part of the outer margin of the group, the dynamic boxing remains unchanged. For example, if William H. Harrison and Theodore Roosevelt switched places (using the shortest path) in FIG. 1-1, the group's hull would be the same (a rectangle around the outermost items in this particular example). By way of another example and without limitation, if William H. Harrison and Theodore Roosevelt switched places (using the shortest path) in FIG. 1-2, the first group and the second group would be affected, but the hull of the third group would not change.

The visual representation of a dynamic boxing is not a requirement for the internal representation in the form of collections (each of which contains the member of a group) and/or group identifiers (a data field in the data structure of an item that indicates the group it belongs to, such as, by way of example and without limitation, a tag or a numerical ID). However, the visual representation of dynamic boxings is recommended because the user may otherwise, in certain situations, expect the programmable electronic device to interpret the positions of the movable graphical objects differently than it actually does. By way of example and without limitation, if a user moved Franklin D. Roosevelt down, there would likely be (in the absence of visual feedback) uncertainty at some point as to whether the item is still a member of the second group, forms a group of its own, or belongs to the first or third group.

If visual feedback is given, it is not necessary to provide it every step of the way, i.e., so frequently that even the smallest part of a multi-part movement would result in a redrawing of the group hull.

Dynamically-boxed item groups can also be ordered. FIG. 2-2 shows an exemplary arrangement of the names of 22 presidents of the United States in four groups. The presidents are grouped by state of birth, and within each group, they are ordered chronologically by term. The two groups on the left are ordered two-dimensionally (horizontally and vertically), while only one dimension (the vertical one) is used in connection with the two groups on the right.

### Identification of Containerless Groups

### Absolute Distance and Proximity Rectangle

Dynamic groups according to the invention are based on proximity. While (as discussed further below) an absolute definition of whether two items belong to the same group is not the only way to identify dynamic groups, it is usually the fastest one.

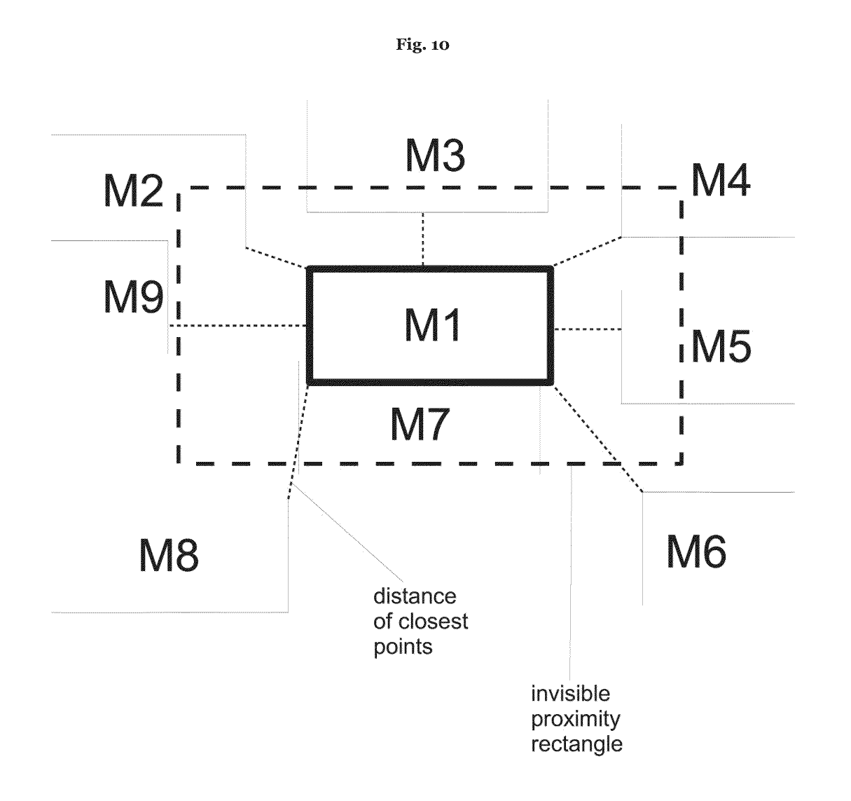

FIG. 10 shows eight exemplary movable graphical objects (M1 to M8), whereby the focus is on the relationships between M1 and each other item. The dashed rectangle corresponds to a (usually invisible) proximity rectangle: any other item that touches the proximity rectangle or is entirely within it, is deemed to be a member of the same group as M1. In the example, M2, M3, M4, M5 and M7 are members of the same group as M1 (with M7 being the clearest case since it even overlaps with M1), while M9 is too far to the left and M6 and M8 are too far down. The distances between M1 on the one hand and M3, M5 and M9 on the other hand (M7 has no distance because it overlaps) correspond to horizontal or vertical lines, while the distances of the closest points between item M1 on the one hand and items M2, M4, M6 and M8 on the other hand correspond to diagonal lines in each case.

In the example, the size of the proximity rectangle casts a wider net (in terms of the distance between the proximity rectangle and the boundaries of item M1) horizontally than vertically. The distances could also be identical.

A proximity rectangle allows the fastest determination of whether two items belong to the same group, provided that the movable graphical object relating to the proximity rectangle has a rectangular shape or a shape that can be efficiently broken up into rectangles. This performance advantage is achieved by avoiding trigonometric computations of item-to-item distances.

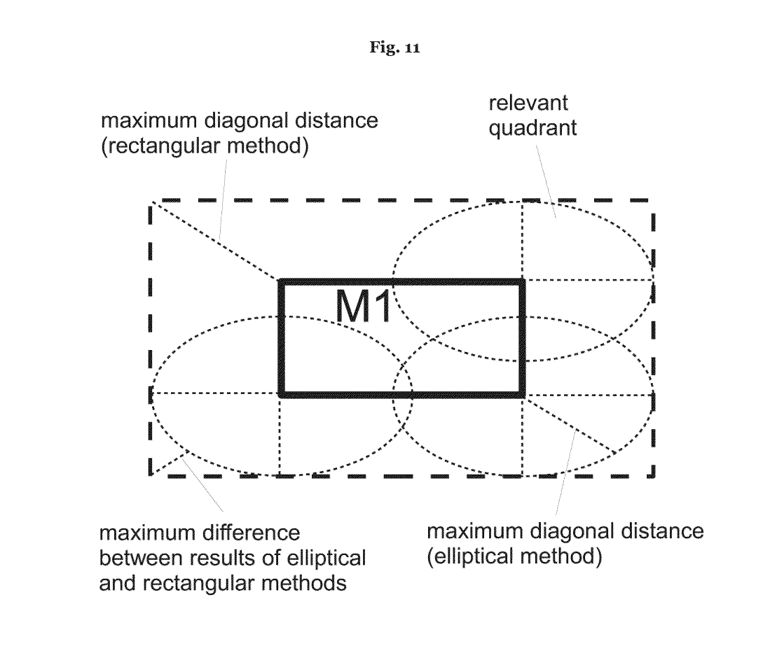

FIG. 11 shows item M1 and a (dashed) proximity rectangle as well as elliptical boundaries in three of the four quadrants. Each corner is the center of one ellipse, and one quadrant of each ellipse is relevant for determining whether two items are close enough to be members of the same group (if the closest points of the two items can be connected by a horizontal or vertical line, the proximity determination is made on a rectangular basis).

The two radii of each ellipse are the maximum vertical distance and the maximum horizontal distance of items belonging to the same group. If those radii were identical, there would be only one radius and the ellipse would be a circle (which would still require trigonometric computations to determine diagonal distances).

A given point with coordinates PX and PY is inside, or on the boundary of, the ellipse centered at CX and CY, with the semi-major axis RX and the semi-minor axis RY, if the following inequality is true:

((PX−CX)²/RX²)+((PY−CY)²/RY²)≦1

As FIG. 11 shows in its lower left corner, the maximum difference between the results of the elliptical and rectangular methods is limited. Each corner of the proximity rectangle is not much further from the closest corner of M1 than the maximum diagonal distance calculated precisely with an elliptical method (as shown in the lower right corner of FIG. 11) would be. Reliance on a proximity rectangle is, therefore, a recommended compromise between performance and precision, especially considering that there is no risk of end user confusion.

### Iterative Group Building

After all item-to-item connections have been identified (i.e., all connections of a first item with a second item because each item is within the other item's proximity rectangle, whereby only one of the two proximity rectangles must be evaluated), the next step is to build groups, i.e., collections of items or item IDs, each of which collections corresponds to one dynamic group.

One recommended way to build groups consists of an outer loop processing different start items and an inner loop that builds a group containing the start item and all other items directly or indirectly connected to that start item. The outer loop starts with a collection of all items or unique identifiers (such as hashcodes) of all items, whereby both the outer and the inner loop remove an item once it is assigned to a group. The inner part of the loop can be a recursive function with a list of items (or unique identifiers of items) yet to assign to a group, the start item (or its unique identifier), a collection representing the dynamic group that is being built, and potentially a unique identifier to be assigned to each member of the group. The function then processes all items connected to the start item and calls itself recursively so as to process the items connected to each item connected to the start item. The following code written in the Microsoft C# programming language for the Microsoft Windows operating system serves this purpose:

```
private void AddItemAndConnectedItemsToGroup(
    SortedList<int, int> hashesOfItemsToAssignToGroupArg,
    int hashOfStartItemArg,
    ContainerlessGroup newGroupArg,
    int newGroupHashArg)
{
    MovableItem startItem =
      movableItemsByHash[hashOfStartItemArg];
    newGroupArg.Add(startItem); // also stores group hash in
                              field of this item
    if (hashesOfItemsToAssignToGroupArg.Count == 0) { return; }
    foreach(int connectedHashLoop in startItem.nearItems.Values)
    {
      if (hashesOfItemsToAssignToGroupArg.ContainsKey(
        connectedHashLoop))
      {
        hashesOfItemsToAssignToGroupArg.Remove(
          connectedHashLoop);
        AddItemAndConnectedItemsToGroup(
          hashesOfItemsToAssignToGroupArg,
          connectedHashLoop,
          newGroupArg,
          newGroupHashArg);
      }
    }
}
```

A person skilled in the art furthermore knows how to perform group building by means of other iterative program structures than a literally-recursive structure, such as (by way of example and without limitation) a loop with or without a stack.

### Relative Distance

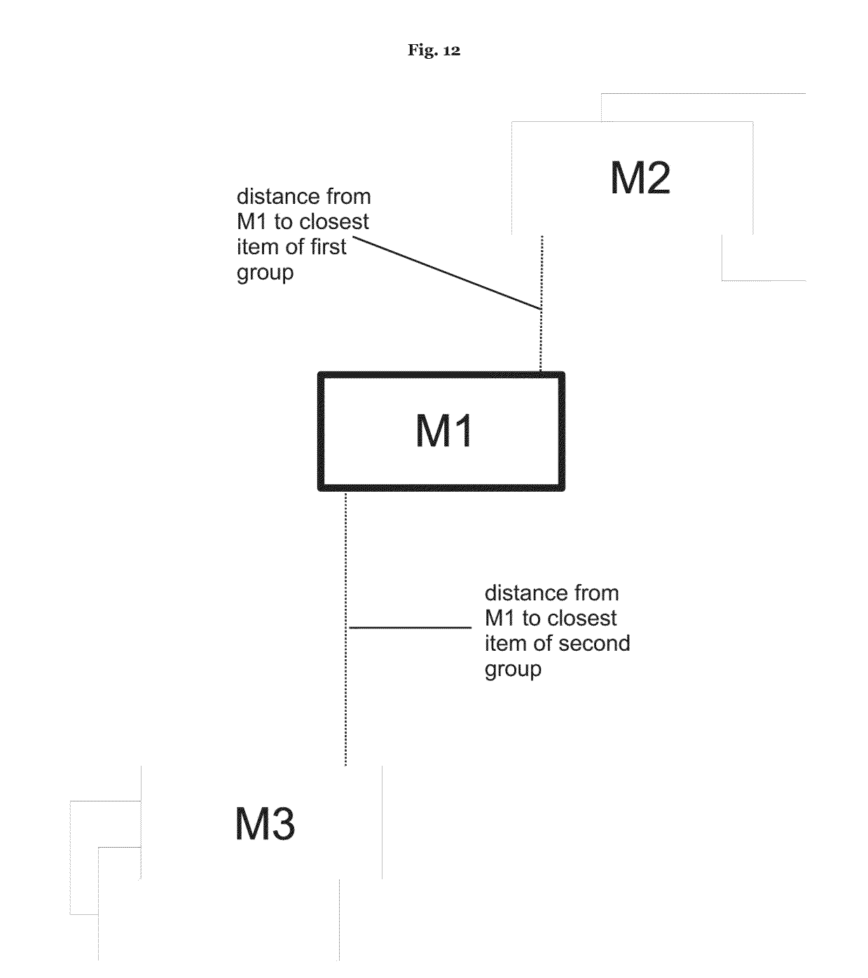

Additionally to a proximity determination based on the absolute distance between any two items, a determination based on relative distance is also possible. FIG. 12 shows three exemplary items (M1, M2 and M3), whereby M2 and M3 are members of groups with other items (the drawing shows items overlapping with them, while no item overlaps with M1). In the example, M1 is significantly closer to M2 than to M3. Depending on the threshold defined (by way of example and without limitation, the rule could be that an item must be twice closer to item A than to item B so as to be connected with item A), this difference in distance can be determinative.

If a determination based on relative distance is performed after groups have been formed based on absolute distance, “orphan” items or smaller “orphan” groups of items can be added to a given group G if they are, by a threshold to be defined, closer to the closest item of G than to the closest item of any other group than G.

### Optimal Distance

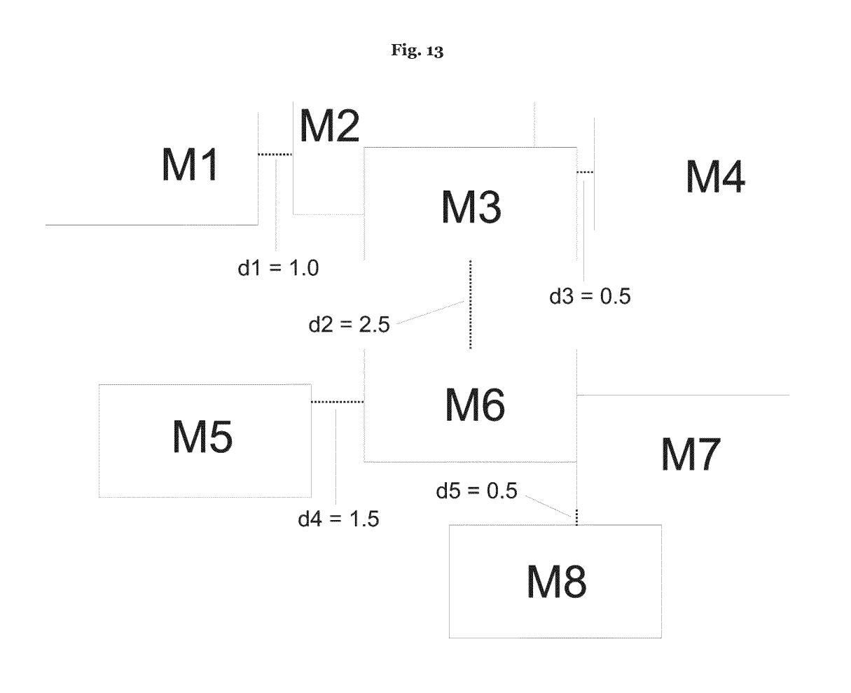

If the overarching objective is to break up the movable graphical objects into a predefined number of groups (for example, because a knowledge quantification system requested the user to form a specific number of groups), it is also possible to determine an optimal distance (or a pair of horizontal and vertical distances) resulting in the predefined number of groups. FIG. 13 shows an exemplary arrangement of eight items. M2 and M3 overlap, and M6 and M7 are adjacent. In those scenarios, there is no doubt that M2 and M3 on the one hand and M6 and M7 on the other hand must be members of the same group. The distances between the closest points of any two non-overlapping and non-adjacent neighbor items range from 0.5 (the distance between M7 and M8) to 2.5 (distance between M3 and M6). Any threshold greater than 1.5 and less than 2.5 would result in two groups.

### Dynamic Boxing

### Convex Hull (Elastic Band)

Dynamic boxing has its maximum screen-space-saving effect if the boundaries of a group, optionally visualized by means of a graphical group hull, form a polygon that is (unless the items are arranged in a rectangular form) closer to the items than a predefined container, such as a rectangular box or window, would be. This way, each group occupies no or only limited screen space beyond the minimum requirement, and leaves a maximum of screen space for all other groups.

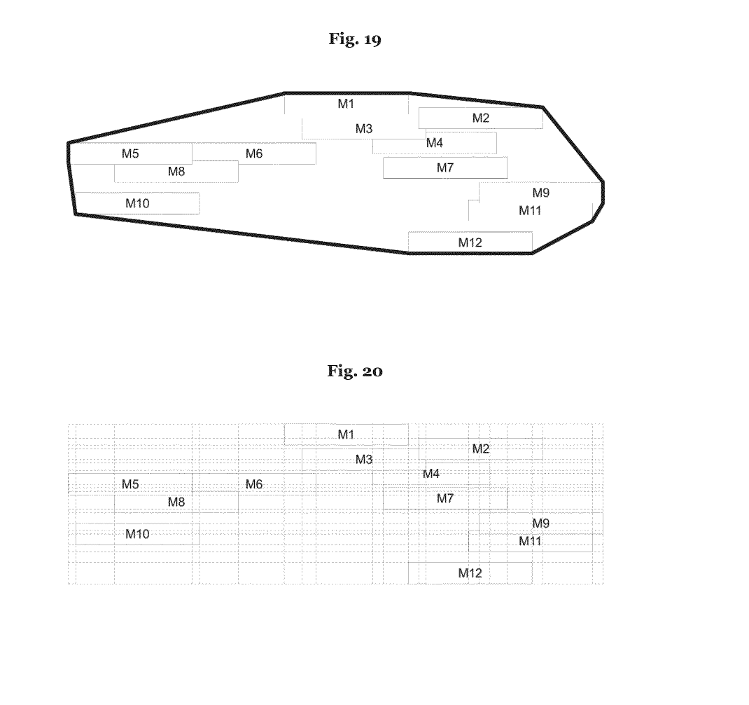

A suboptimal but possible method is to compute the convex hull, or convex envelope, that contains all corners of the movable graphical objects in the group, comparable to an elastic band stretched around those corner points. FIG. 19 shows a convex hull around an exemplary dynamic item group.

Various algorithms exist in computational geometry to determine a complex hull, including but not limited to Gift wrapping (also known as the Jarvis march), the Graham scan, the Eddy-Bykat QuickHull, the Preparata-Hong Divide-and-Conquer approach, the Monotone chain (also known as Andrew's algorithm), the incremental convex hull algorithm by Michael Kallay, the ultimate planar convex hull algorithm by Kirkpatrick-Seidel, Chan's algorithm, and the Liu and Chen algorithm (see http://en(dot)wikipedia(dot)org/wiki/Convex_hull_algorithms).

### Concave Hulls and Alpha Shapes

One disadvantage of a convex hull for the purpose of dynamic boxing is illustrated by FIG. 19: there is a significant amount of space between M10 and M12, yet those items are connected directly, making the group claim screen space some of which might otherwise be available to another group. The convex hull allows any of the points contained by it to be connected with each other without leaving the hull.

Algorithms exist in computational geometry for generating a concave hull or alpha shape. See Duckham et al., Efficient generation of simple polygons for characterizing the shape of a set of points in the plane, and WO 2008/107895 A1 by Moreira et al., Process for the automatic calculus of the convex or concave hull of an arbitrary set of points. Concave hulls can avoid some of the inefficiencies of convex hulls in connection with dynamic groups, but require substantial computing resources. It is difficult and resource-consuming to perform a point-by-point analysis that applies the same proximity rules as the group-building algorithm, which focuses on the actual (for example, rectangular) shape of each movable graphical object. However, the same rules must be applied so as to avoid overlaps between the graphical hulls of dynamic groups, which would confuse users.

### Identification of Outermost Points by Means of Two-Dimensional Normalization

For the identification of the outermost points of a dynamic group of items, embodiments of the invention can, but need not, perform a two-dimensional normalization of all movable graphical objects belonging to the group. FIG. 20 shows an exemplary two-dimensional normalization of a group consisting of 12 rectangular items. In many or even most cases, users will place items in positions in which items are rarely aligned on one or more sides. In a worst-case scenario, the number of different coordinates on each axis will be twice the number of items, and in many realistic scenarios, including the exemplary arrangement shown in FIG. 20, the number of coordinates on each axis will be close to twice the number of items, resulting in a large number of segments.

Normalization is in many cases not sufficient in and of itself to determine the coordinates of a suitable group hull because of the phenomenon hereinafter called “inward straits” and described further below.

### Identification of Each Next Vertex Based on Nearby Items

The most efficient way to identify the coordinates of a dynamic boxing, in connection with rectangular graphical objects or graphical objects that can be efficiently split up into rectangles, is to start at an initial vertex (by way of example and without limitation the leftmost corner with the minimum Y coordinate, the rightmost corner with the minimum Y coordinate, the leftmost corner with the maximum Y coordinate, or the rightmost corner with the maximum Y coordinate) and to work one's way from one vertex to another until the initial vertex is reached again.

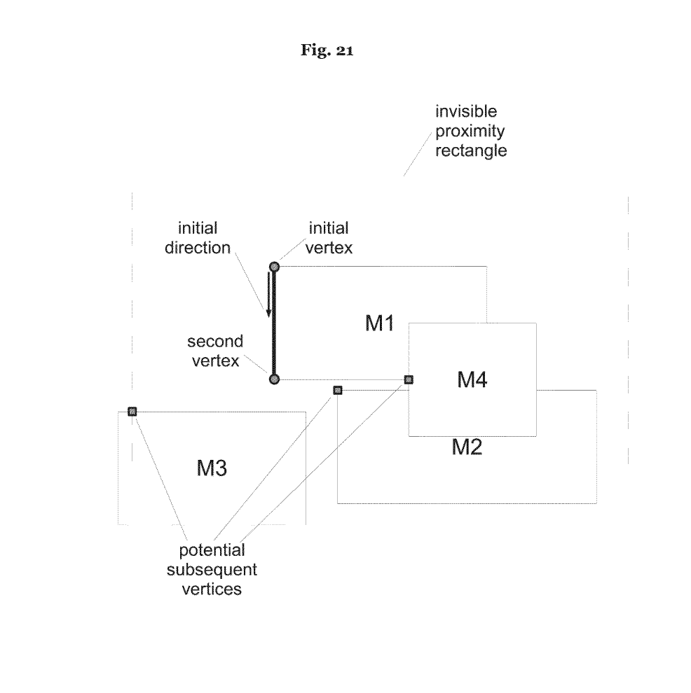

FIG. 21 shows an initial vertex at the upper left corner of item M1, and a second vertex at the lower left corner of the same item. In this example, the initial direction was down, which is how the second corner was identified. Thereafter, the search continues in the same (down) direction, and three potential subsequent vertices are identified: the intersection of the bottom side of M1 with the left side of M4; the upper left corner of M2; and the intersection of the top side of M3 with the left side of the (invisible) proximity rectangle around M1. With respect to the latter, it is key to limit the search for subsequent vertices to the proximity rectangle.

The proximity determinations made when determining which items are connected (i.e., belong to the same group) can be reused for this purpose, resulting in very significant efficiency gains over any algorithm that would have to start with a larger set of points and process all of them without sorting or sort them before or while processing them.

### Avoiding or Minimizing Inward Straits

As the hull-building algorithm works its way from vertex to vertex, there will be collinear connections (i.e., at least three vertices are on the same line), outward moves, and inward moves. If the hull-building algorithm is likened to a person walking around a building of an arbitrary shape with a counter-clockwise orientation, “outward” means that the person has to turn, from its own perspective as opposed to the bird's-eye view, to the right in order to avoid collision with a wall of the building, while “inward” means that the person has to turn, from its own perspective as opposed to the bird's-eye view, to the left in order to find the next corner.

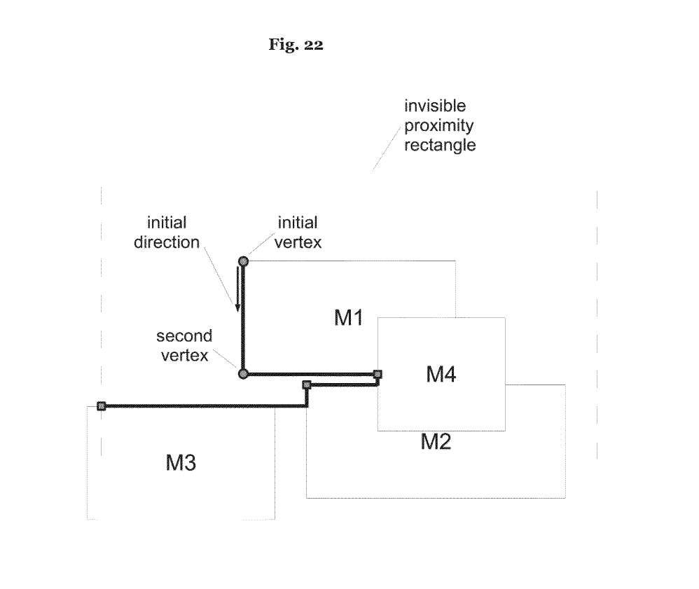

FIG. 22 shows the problem (which normalization would not be able to solve in and of itself) of an inward strait: by connecting the second vertex with the closest potential subsequent vertex (the intersection of the bottom side of M1 with the left side of M4) and then following along the edges of the items to the other potential subsequent vertices, a narrow passage is formed between items M1 (top), M4 (right), and M2 (bottom). A graphical group hull providing visual feedback to the user would typically be drawn at a certain minimum distance from the edges of the items it encompasses; at least the hull line would be thick enough so that part of the hull has a distance from the edges of the items. If two parallel segments of the hull are too close to each other, they will end up being adjacent or they will even overlap.

Apart from visual and usability considerations, if item M4 did not exist in FIG. 22 and if the hull-building algorithm always made a connection with only the closest potential subsequent vertex, it would connect all four corners of item M1 but never reach items M2 and M3.

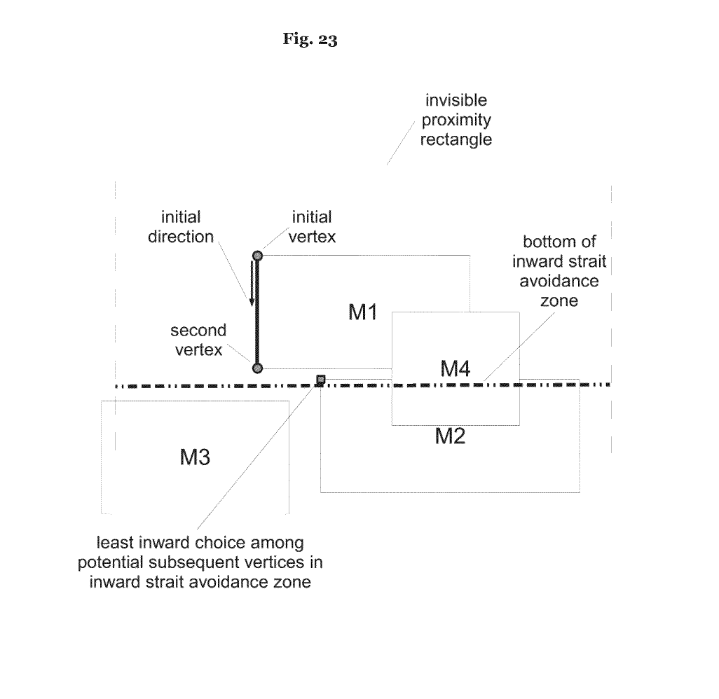

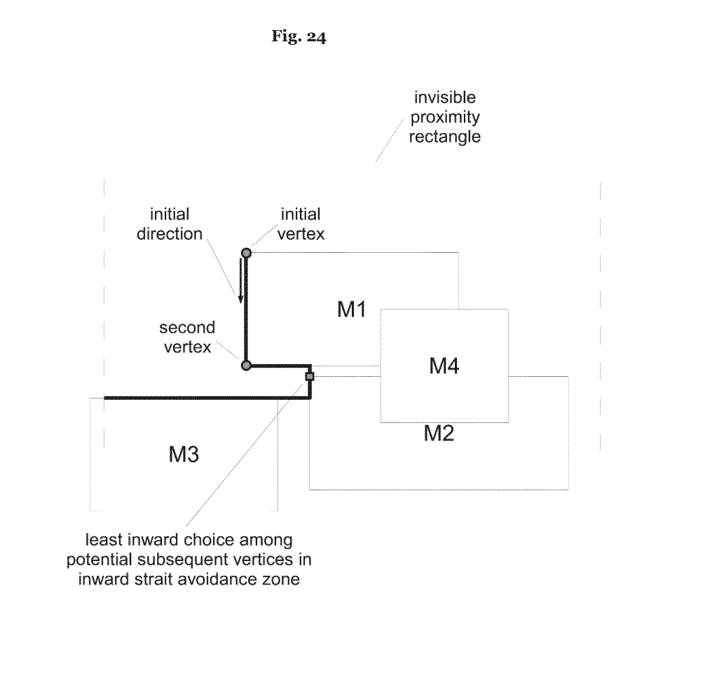

The inward strait in the example could be avoided by, for example, defining an inward strait avoidance zone, i.e., a region in which all potential subsequent vertices are compared to each other and the least inward one will become the next vertex, even if another more inward option is closer in the direction of movement. FIG. 23 shows by means of a dashed and dotted line the bottom of an invisible inward strait avoidance zone. In this example, the upper left corner of item M2 is the least inward choice among potential subsequent vertices in the inward strait avoidance zone, and would therefore have priority over other potential subsequent vertices in the inward strait avoidance zone. FIG. 24 shows that this would result in an inward strait that is much less narrow, and goes less far inward, than the one previously shown in FIG. 22.

Alternatively to a dedicated inward zone avoidance strait, it would also be possible (and is recommended) to choose the least inward item among all items connected to the item of the originating vertex.

### Reduction of Number of Outward Corners

While outward vertices do not raise the issue of potentially-adjacent or potentially-overlapping graphical hulls, it may nonetheless be desirable for visual and/or performance reasons to minimize the number of outward vertices. If an inward strait avoidance zone is defined, it could be used not only to avoid or minimize inward straits but also for identifying the most outward vertex within the zone. Alternatively, there could be an outward corner minimization zone dedicated to this purpose, or the most outward vertex could be chosen among all items connected to the item of the originating vertex.

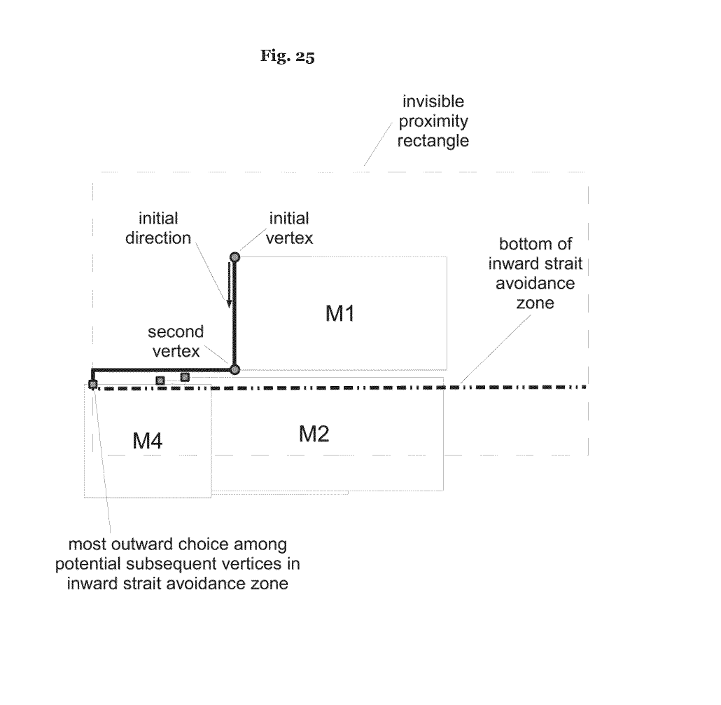

FIG. 25 shows an exemplary arrangement of items in which the inward strait avoidance zone, which in this example also serves the purpose of minimizing the number of outward corners, encompasses three potential subsequent vertices, with the most outward one (the intersection of the top side of M4 with the left side of the proximity rectangle) the one to be chosen for the purpose of minimizing the number of outward corners.

One problem with making a connection to the most outward vertex, if that one is not also the closest vertex, is that the hull has to go around the area in which there could be other objects. In FIG. 25, the hull makes a 90-degree outward turn from the second vertex before making another 90-degree turn toward the most outward vertex. If the hull continued straight from the second vertex down toward the Y coordinate of the top side of M4 (in order to then turn toward the most outward vertex), it would intersect with item M2. The hull should contain the entirety of all items in the group.

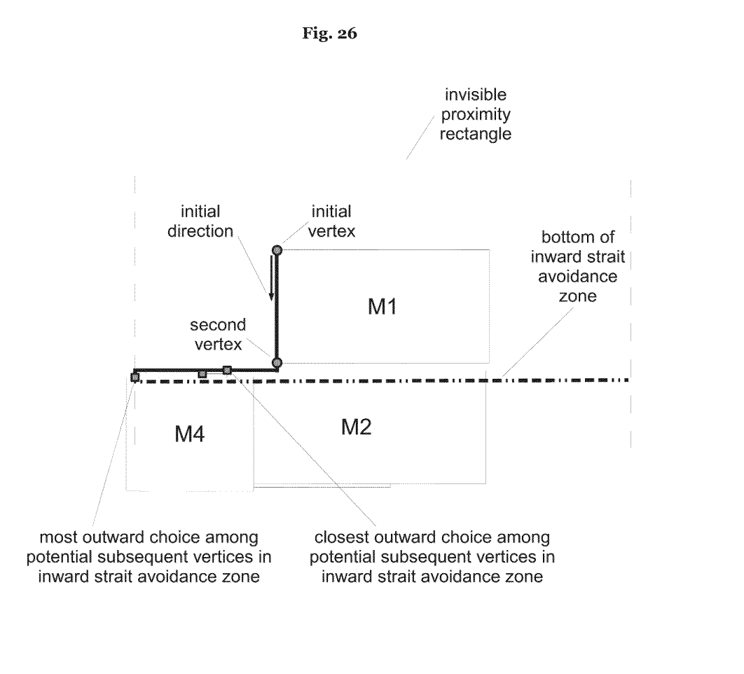

FIG. 26 shows an exemplary optimization addressing this issue at least in part. In that example, the search is not limited to the most outward vertex in the inward strait avoidance zone. The closest outward vertex (inward vertices can be ignored if the actual connection is outward), i.e., the top left corner of item M2, is additionally identified, and the hull goes initially to the closest outward vertex and only then turns outward, thereby staying closer to the items than the example in FIG. 25.

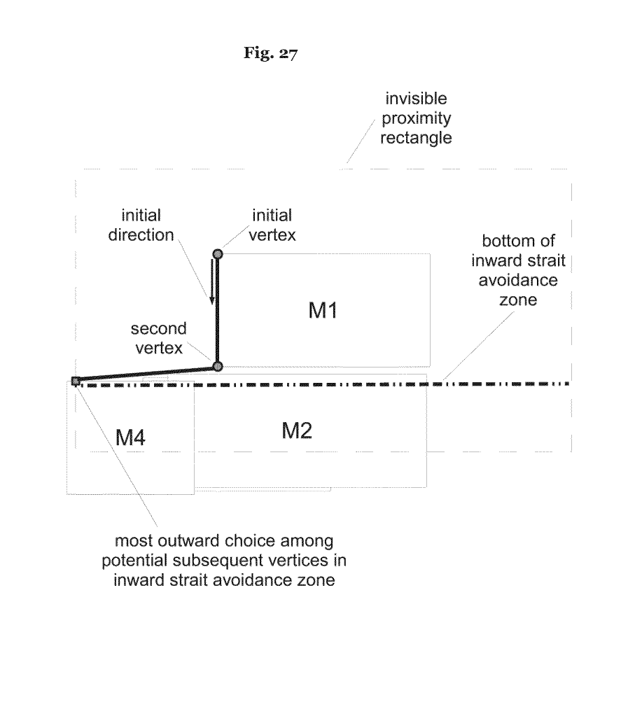

FIG. 27 shows another alternative: an exemplary diagonal connection from the second vertex to the most outward vertex. A diagonal connection requires an analysis as to whether there would be intersections with any items in between the two vertices. Identifying intersections involving a diagonal line require more processing time, however, than in the case of intersections of vertical and horizontal lines. This can also cost processing time in subsequent steps, for example, when techniques such as ray casting are used to identify enclave groups (see further below).

### Diagonal Connections

Even two items that are closest neighbors may have a diagonal position relative to each other. In the exemplary arrangement of items in FIG. 10, item M2 is located above and to the left of item M1, while item M4 is located above and to the right of item M4. M2 and M4 are nonetheless connected with item M1 because they touch the proximity rectangle. Item M8 is located below and to the left of item M1. Item M6 is located below and to the right of item M1. Items M6 and M8 are outside the proximity rectangle, however.

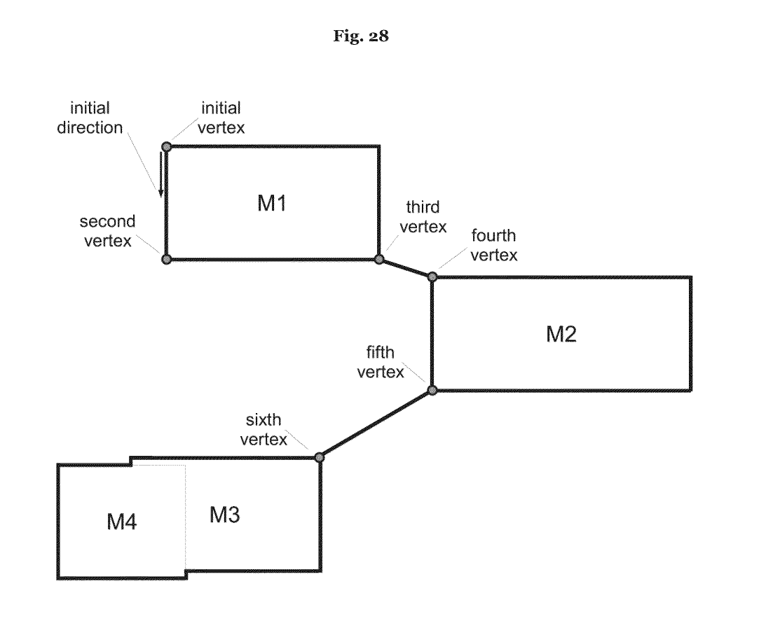

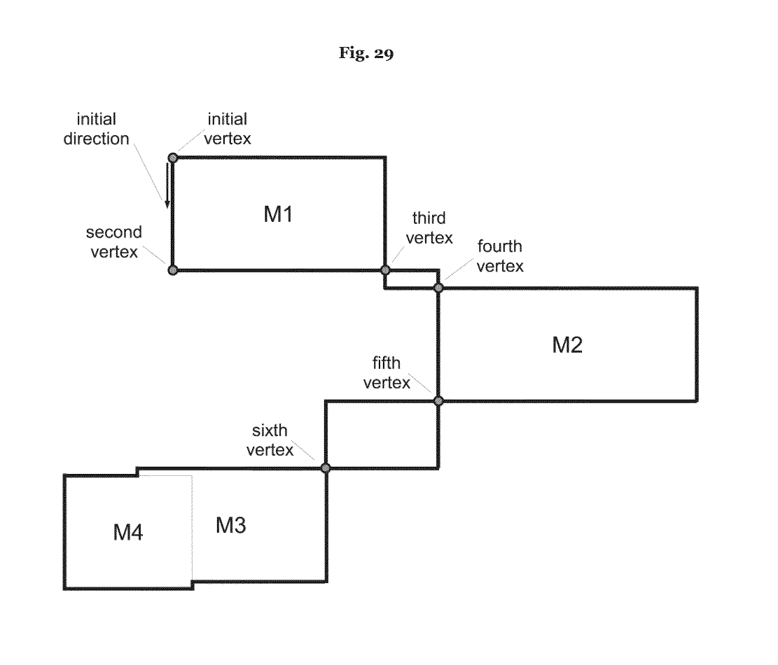

For bridging a diagonal gap between subsequent corners, there are alternative approaches. FIG. 28 shows an exemplary arrangement of items in which the fifth vertex and the sixth vertex are connected by a diagonal line, which would also be the form of the graphical hull. Alternatively, two items can be connected across a diagonal gap with orthogonal lines as shown in FIG. 29. It is merely a matter of internal data organization whether additional vertices are created in the internal data structures or whether additional vertices are generated only for visual purposes when drawing a graphical hull. Furthermore, it is merely a design question whether the graphical hull would then have self-intersecting lines (as in FIG. 1-2, where Franklin D. Roosevelt and Theodore Roosevelt are connected across a diagonal gap with self-intersecting orthogonal lines).

### Keeping Distance Between Boxings and Items

While not strictly necessary, it is recommended to keep a distance between the graphical hull of a dynamic boxing and the boxed graphical objects.

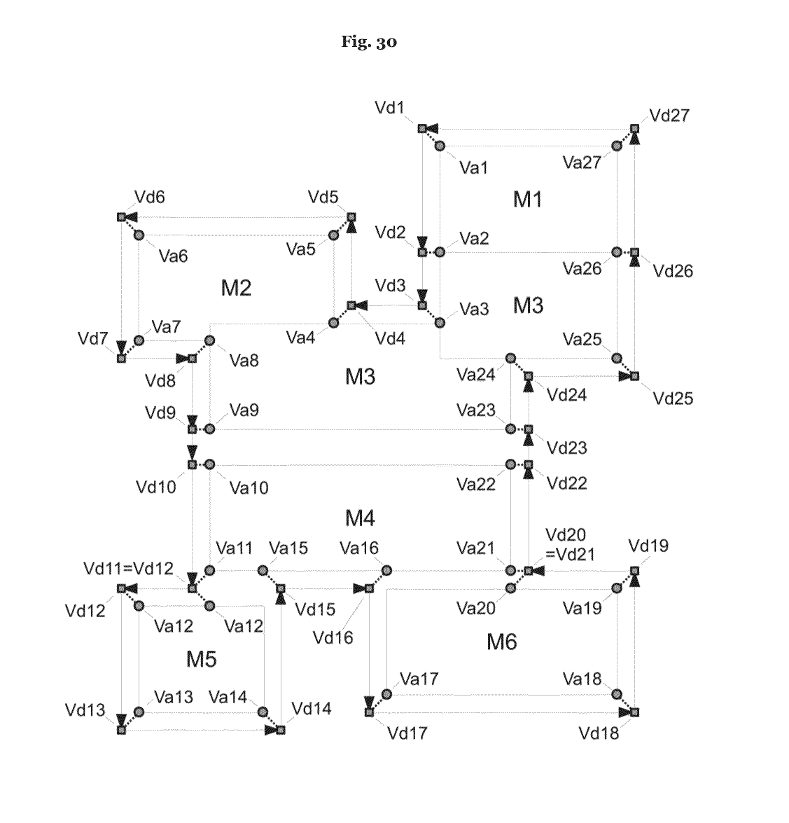

FIG. 30 shows an exemplary arrangement of movable graphical objects (M1 to M6) with 27 actual vertices (Va1 to Va27) and 27 corresponding display vertices (Vd1 to Vd27), whereby display vertex Vd11 is identical to display vertex Vd12 and display vertex Vd20 is identical to display vertex Vd21. This example purposely demonstrates alternative approaches as to how many vertices can be generated, and equally purposely contains redundant vertices, which could be avoided in the first place or eliminated subsequently. For example, the five vertices Va8 to Va12 are collinear, rendering Va9 to Va11 (and the corresponding display vertices Vd9 to Vd11) redundant.

The fact that display vertex Vd11 is identical to display vertex Vd12 is due to the fact that actual vertices Va11 and Va12 are collinear and the vertical distance between them is exactly twice the (predefined) vertical offset determining the distance between the graphical hull and the boxed objects. Within a certain range, the horizontal and vertical display vertex offsets are arbitrary. That range is limited by the possibility of overlaps or adjacent lines. If the offset in a certain direction is less than or equal to 50% of the maximum vertical distance between connected items, overlaps or adjacent lines can occur when the hull is drawn. Also, hull lines can be close to each other in the event of inward straits. As discussed before, inward straits can be avoided or minimized.

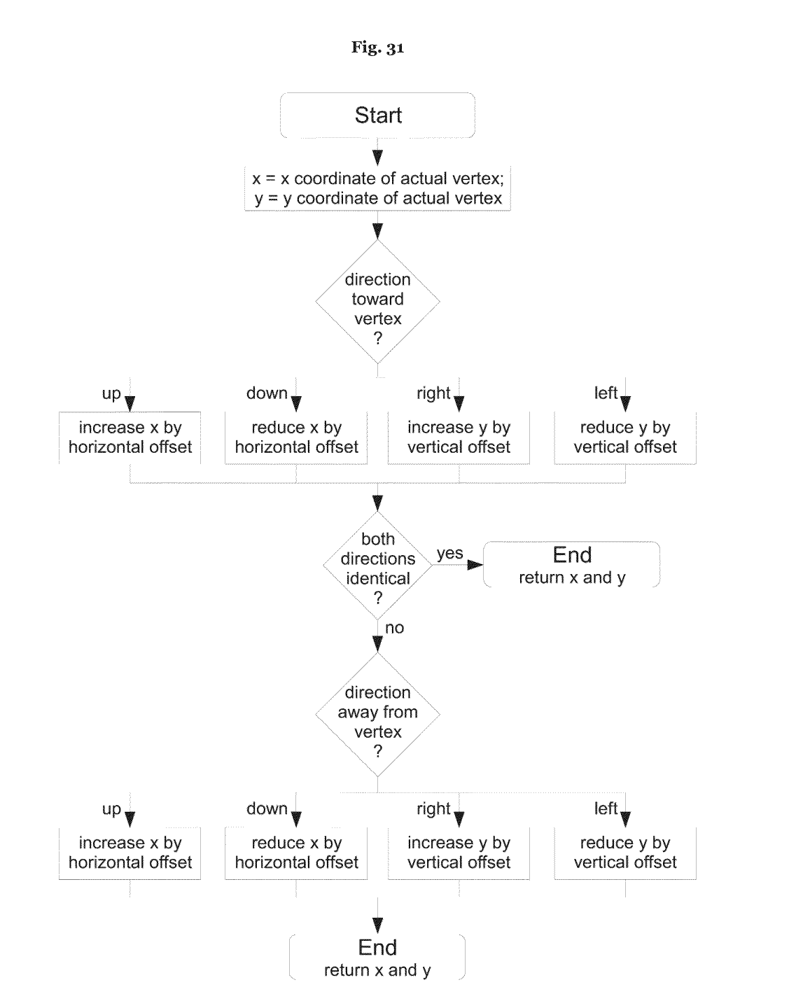

FIG. 31 is an exemplary flowchart for converting an actual vertex into a display vertex. At the start of that routine, variable x contains the X coordinate of the actual vertex in question, and variable y contains the Y coordinate of the actual vertex in question. The function modifies x and y as needed in order for x and y to represent the coordinates of the display vertex, which are ultimately returned. In one step (which is the first step in the example, but need not be the first step), the focus is on the direction in which the vertex in question is approached. If that direction is upward, the boxed objects are located to the left of the vertex (because the sequences of vertices is, as in FIG. 30, counter-clockwise; a person skilled in the art knows how to apply the same principles to a clockwise orientation as well), which is why x is increased by the offset. If that direction is downward, the boxed objects are (due to the aforementioned counter-clockwise orientation) located to the right of the vertex, and x is reduced by the horizontal offset. If that direction is right, the boxed objects are (due to the aforementioned counter-clockwise orientation) located above the vertex, and y is increased by the vertical offset so as to position the display vertex below the actual vertex. Throughout this specification, the coordinate system is based on that commonly found in computer graphics, with the origin (0; 0) being the top left corner of the screen. If the direction of the approach to the vertex is left, the boxed objects are (due to the aforementioned counter-clockwise orientation) located below the vertex, and y is reduced by the vertical offset so as to position the display vertex above the actual vertex.

If the direction from that vertex to the next vertex is the same as from the previous vertex to that vertex, x and y are returned because otherwise the same offset would be applied twice in the following step, which is identical to the first step. It would also be possible to evaluate the direction away from the vertex prior to the direction of the approach toward the vertex.

The horizontal and vertical offsets determining the distance between a graphical hull and the boxed objects can be identical, which could simplify the program code performing the related functions.

### Dynamic Boxing Zones

The distance in the direction of movement is, for example, the vertical distance if the direction of movement is downward. It is possible to evaluate all items connected to the item of the originating vertex (i.e., all items part or all of each of which falls within the proximity rectangle) without distinction based on the distance in the direction of movement. However, as discussed further above, an inward strait avoidance zone and/or a zone for the reduction of the number of outward movements can be useful.

Two zones necessarily require special treatment.

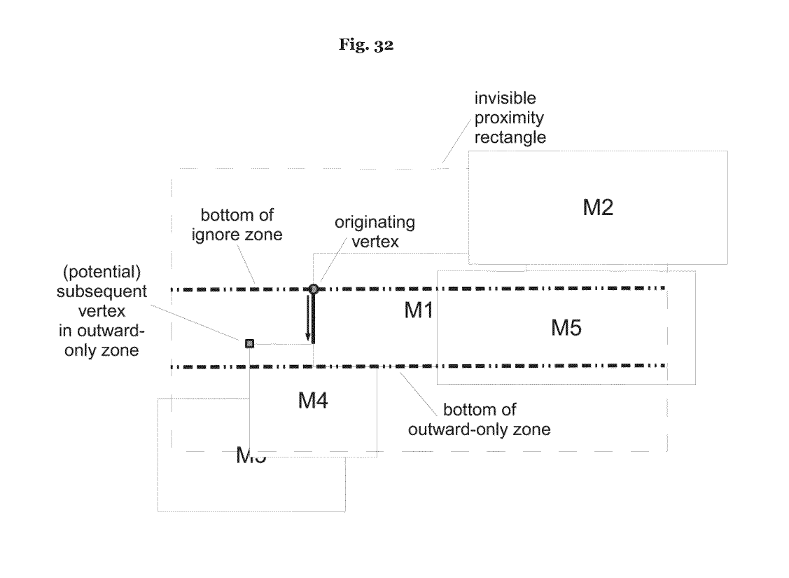

FIG. 32 shows an exemplary arrangement of items in a scenario in which the direction of movement is downward. The upper one of the two dashed and dotted lines is the bottom of the ignore zone, i.e., the zone covering all Y coordinates between the top of the visible area (i.e., the proximity rectangle) and the Y coordinate of the originating vertex. If there are any items in the ignore zone such as item M2 in the example, the hull-building operation must have reached them before or may still reach them later, but certainly cannot reach them in the very next step.

The lower one of the two dashed and dotted lines is the bottom of the outward-only zone, which is the bottom of the item of the originating vertex (item M1). The top of the outward-only zone is immediately below the bottom of the ignore zone. Item M5 is partly in the ignore zone, partly in the outward-only zone, and partly in the standard zone (below the outward-only zone). If there was no outward-only zone, the left side of item M5 (to the extent that it is not in the ignore zone) would otherwise be the next destination, but the hull would then enter item M1 instead of staying at the margin of the boxed items. In the outward-only zone, however, only those potential subsequent vertices that are outward count. In the example, the top left corner of item M4 meets that criterion. The only part of inward item M5 that would be eligible as a vertex is the part below the outward-only zone. That part is, however, vertically further from the originating vertex than the top left corner of item M4.

FIGS. 33-1 and 33-2 to FIG. 36 show exemplary coordinates, in a subset of a proximity rectangle, for up to four zones: an ignore zone, an outward-only zone, a close-range zone (which could serve the purpose of an inward strait avoidance zone or the purpose of a zone for the reduction of the number of outward movements or both), and a standard zone (i.e., everything else).

In each figure, Vx is the X coordinate of the originating vertex, and Vy is its Y coordinate, and an arrow indicates the direction of movement.

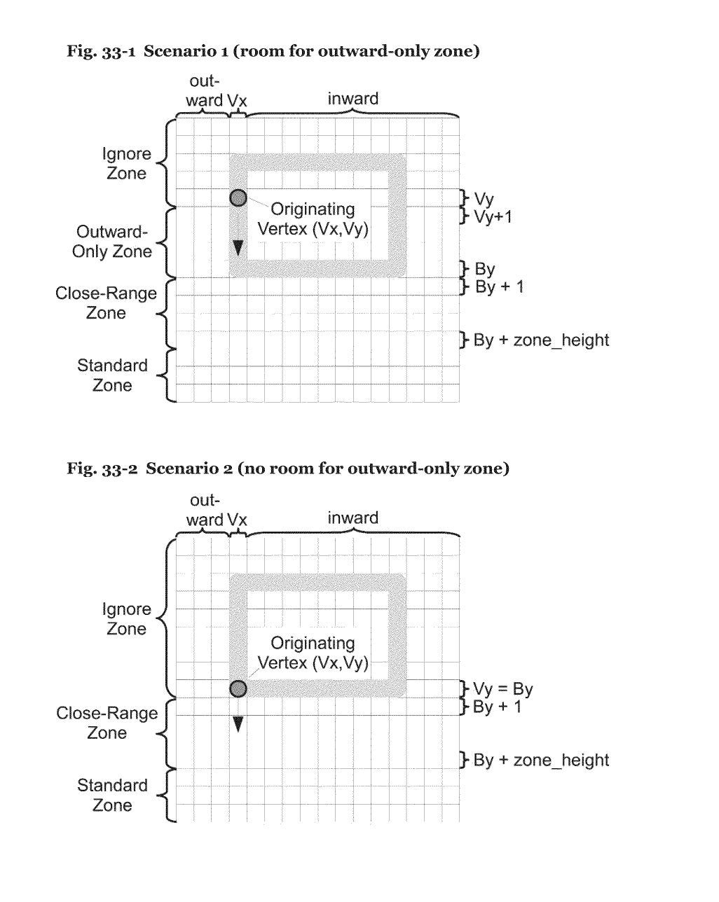

In FIG. 33-1, all four zones are defined. “By” stands for the (Y) coordinate of the bottom of the item of the originating vertex, and zone_height stands for the predefined size of the close-range zone, which size can be defined arbitrarily (except that it is recommended to consider the space requirements of a graphical hull). FIG. 33-2 differs from FIG. 33-1 in that there is no room for an outward-only zone because the originating vertex is at the relevant edge of its item (Vy=By). In that case, the ignore zone is followed directly by the close-range zone, or it could also be followed immediately by the standard zone if no close-range zone is defined.

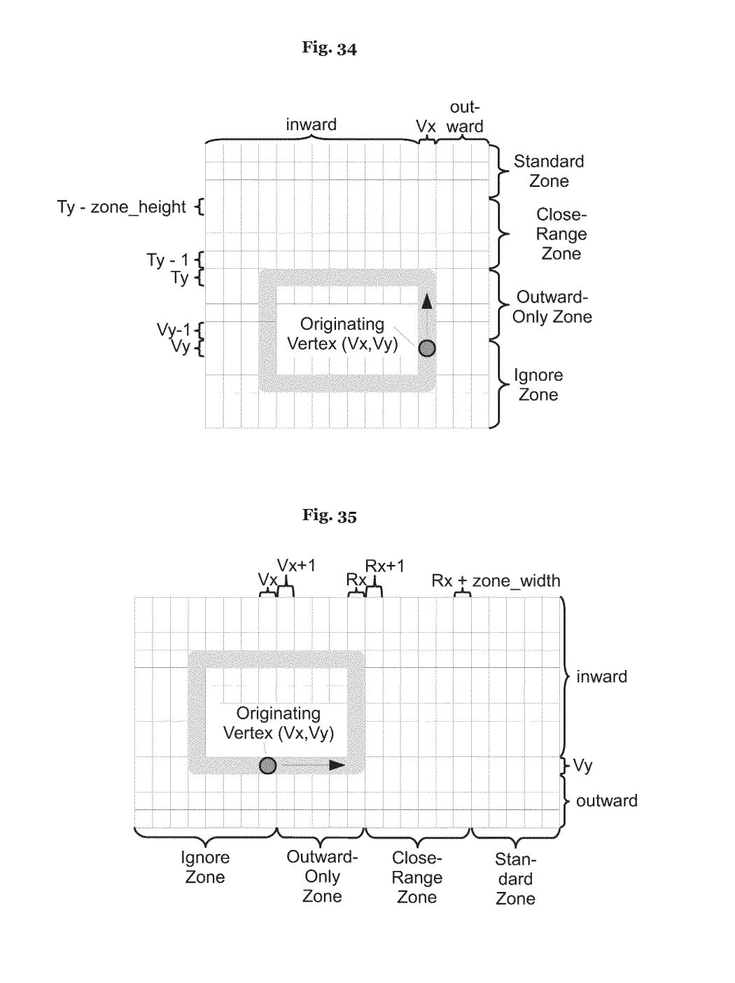

This possibility of having no room for an outward-only zone applies to all directions of movement, but FIGS. 34 to 36 focus on four-zone scenarios, given that a person skilled in the art knows how to handle other situations in which an originating vertex is at the relevant edge of its item.

In FIG. 34, the direction of movement is upward, and Ty stands for the (Y) coordinate of the top of the item of the originating vertex.

In FIG. 35, the direction of movement is right, Rx stands for the (X) coordinate of the right side of the item of the originating vertex, and zone_width stands for the for the predefined size of the close-range zone, which size can be defined arbitrarily (except that it is recommended to consider the space requirements of a graphical hull).

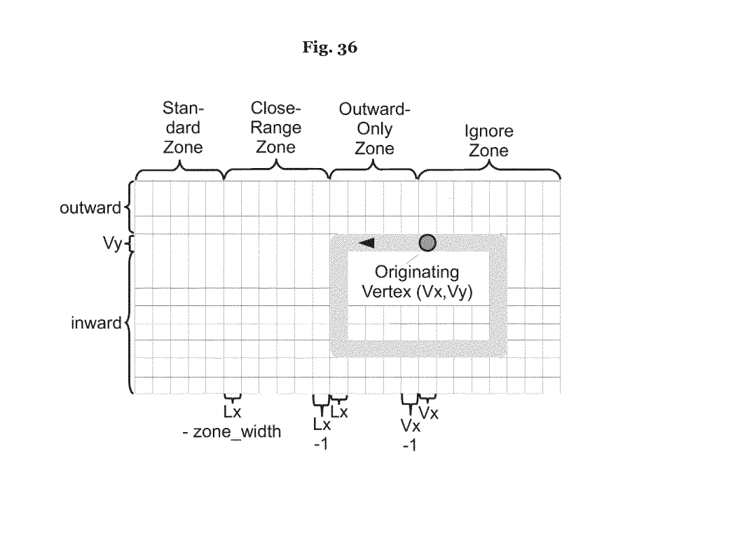

In FIG. 36, the direction of movement is left, and Lx stands for the (X) coordinate of the left side of the item of the originating vertex.

### Searching for Subsequent Vertex in all Zones

FIGS. 37-1, 37-2 and 37-3 are exemplary flowcharts for the search for a subsequent vertex in a scenario in which a loop processes all items connected with the item of the originating vertex based on proximity (i.e., part or all of each of those items falls within the proximity rectangle of the item of the originating vertex) and in which there are an ignore zone, an outward-only zone, and a standard zone (but no close-range zone, which is optional). The loop identifies the best (if any) item for the next vertex. It stores its findings (the least inward item, the most outward item, and the closest outward item) in different variables. A person skilled in the art knows how to alternatively perform more analyses and store the results in additional variables, or how to alternatively skip certain analyses or reduce the number of variables by making fewer distinctions.

In the example, what is first analyzed is whether the loop item is (only) in the ignore zone. If it is, the loop continues with the next item. This need not be the first step, but it is a recommended one. A person skilled in the art knows how to rearrange the order in which certain decisions are made. The exemplary flowchart shows only one of various possible sequences of analyses and decisions.

If the loop item is not ignored, the position of a potential subsequent vertex on that item is analyzed and categorized as inward, collinear, or outward. For example, if the direction of movement is downward (and counter-clockwise, i.e., downward movement occurs on the left side of an item), the relevant side of the loop item is its left side; if the left side is outside of the proximity rectangle, the relevant X coordinate is the left coordinate of the proximity rectangle. In this particular example, a movement is inward if the relevant X coordinate is greater than the X coordinate of the originating vertex, collinear if the relevant X coordinate and the X coordinate of the originating vertex match, and outward if the relevant X coordinate is lower than the X coordinate of the originating vertex.

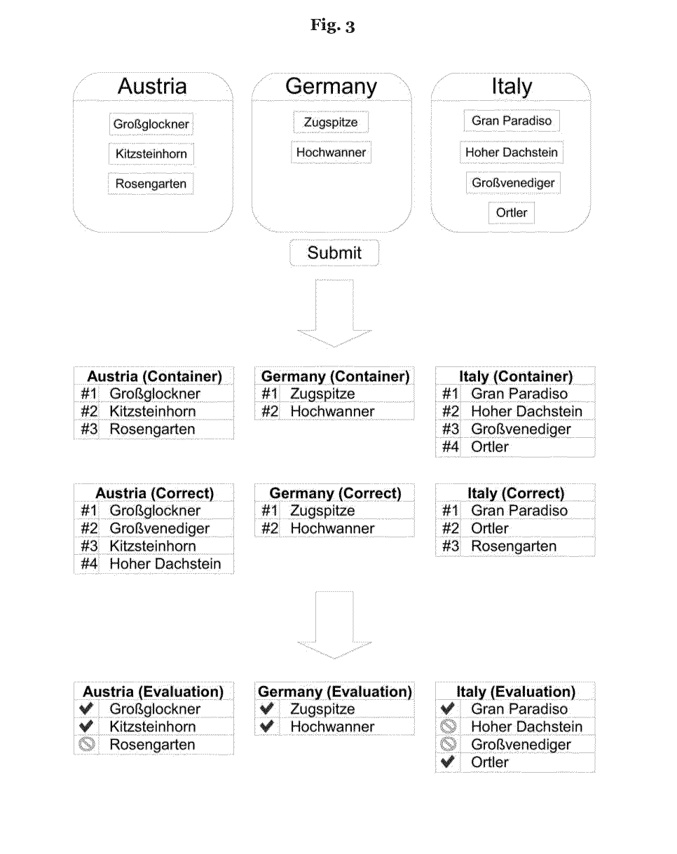

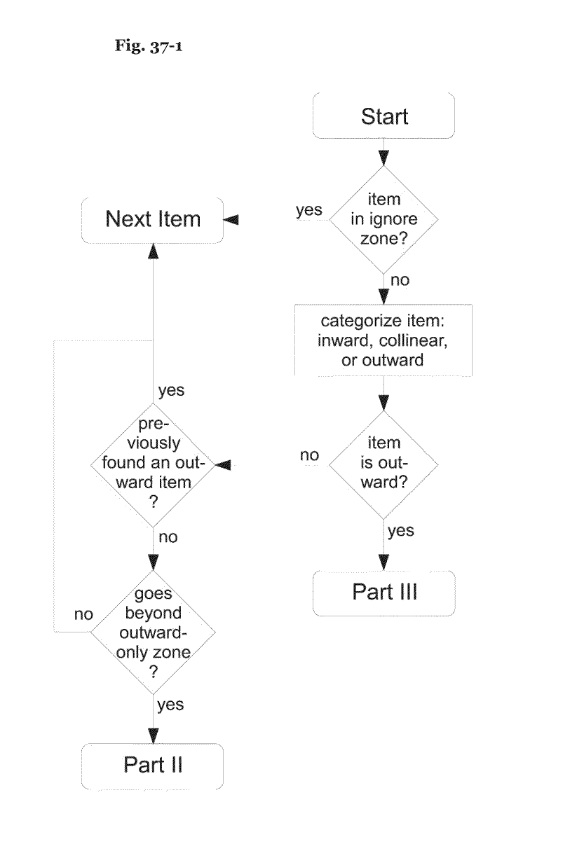

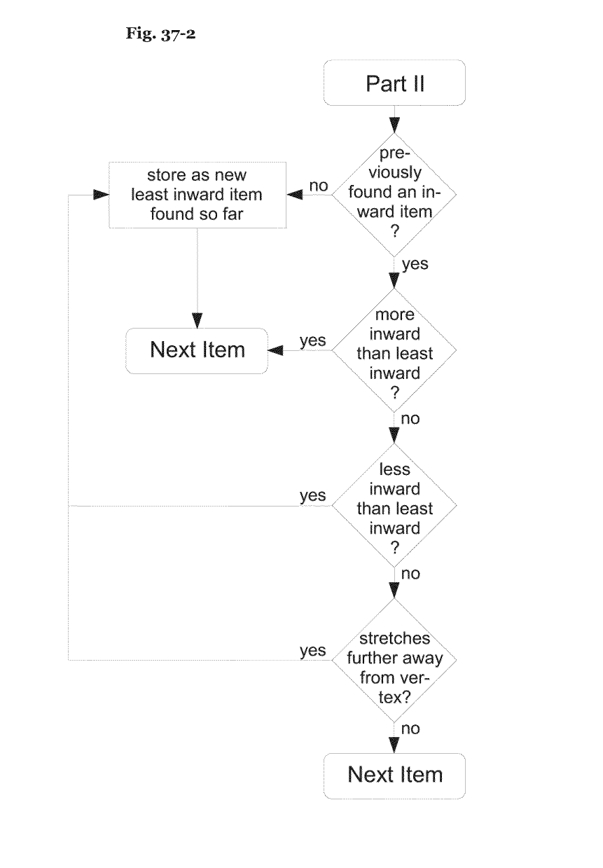

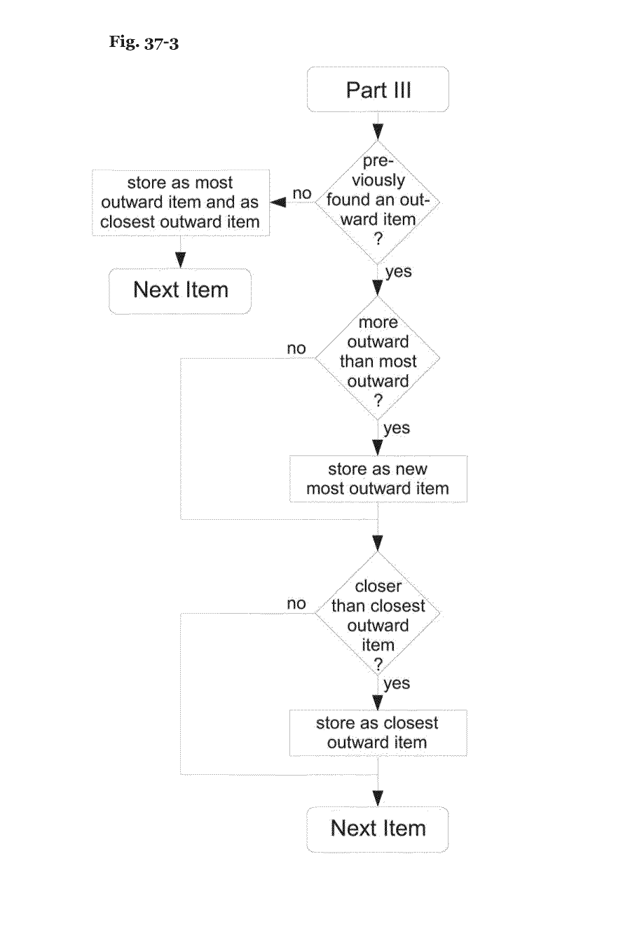

In the exemplary flowchart, the next decision depends on whether the loop item is or is not outward. If the item is outward, the flowchart continues with the part shown in FIG. 37-3 (discussed below). If the item is not outward (i.e., it is collinear or inward), it can be ignored if an outward item has previously been found and if it is a design goal (as it is in the exemplary flowchart) to avoid inward straits whenever there is an alternative within the proximity rectangle. The collinear or inward item can also be ignored if it does not reach beyond the outward-only zone. If the collinear or inward item does reach beyond the outward-only zone, the exemplary flowchart continues with the part shown in FIG. 37-2 (discussed below).

FIG. 37-2 of the exemplary flowchart handles a loop item that is not (at least not entirely) in the outward-only zone and that is inward or collinear, in a scenario in which no outward item has been found yet. Where that part of the flowchart refers to “inward”, it means “inward or collinear” since no distinction is made between the two during this part of the flowchart (these types of items are merely compared against each other based on the relevant coordinate). The first decision in the exemplary flowchart depends on whether any inward (i.e., inward or collinear, for the reason explained above) item has been found before. If not, this loop item is stored in the variable containing the new least inward item and the loop continues with the next item. Otherwise, the next check is whether it is more inward than the least inward. If it is, then it will be ignored because it is a design goal in the exemplary flowchart to at least minimize inward straits where they cannot be avoided. If the item is less inward than the least inward item found so far, it is stored in the variable containing the new least inward item and the loop continues with the next item. Thereafter, it is certain that item is equally inward as the least inward item previously found. In that scenario, if the current loop item stretches further away from the vertex, it is stored in the variable containing the new least inward item and the loop continues with the next item. This last step is optional. It can, however, result in efficiency gains.

FIG. 37-3 of the exemplary flowchart handles a loop item that is outward (and cannot be ignored). If no outward item has previously been found, this item is stored in the variable containing the most outward item as well as in the variable containing the closest outward item, and the loop continues with the next item. Otherwise, it replaces the item in the variable containing the most outward item found so far if it is more outward than that one, and/or it replaces the item in the variable containing the closest outward item if it is closer to the vertex (in the direction of movement) than the closest outward item found before.

After the loop has processed all items connected (based on the proximity rectangle) with the item of the originating vertex, the variables contain different findings, and some or all variables may still contain their initialization value, a null reference. Based on the findings, the next step is to determine on which item to identify the next vertex.

As vertices are built, it is efficient to store as a data field of each vertex object the direction in which the vertex is approached and the direction of movement away from the vertex. Alternatively, the directions could be identified later (for example, if needed for determining the coordinates of display vertices) by comparing the coordinates of consecutive vertices.

### Building Subsequent Vertices I: Collinear Continuation

If the item chosen to be the item of the next vertex is collinear (i.e., both vertex items share the same relevant coordinate), it may be possible to simply replace the originating vertex with the next vertex provided that the direction in which both vertices are approached is identical.

FIGS. 38-1a, 38-1b, 38-2a, 38-2a, 38-3a, 38-3h, 38-4a and 38-4b show, each in an exemplary subset of a proximity rectangle with exemplary items and vertices, the determination of the coordinate of the subsequent vertex in a collinear-continuation scenario.

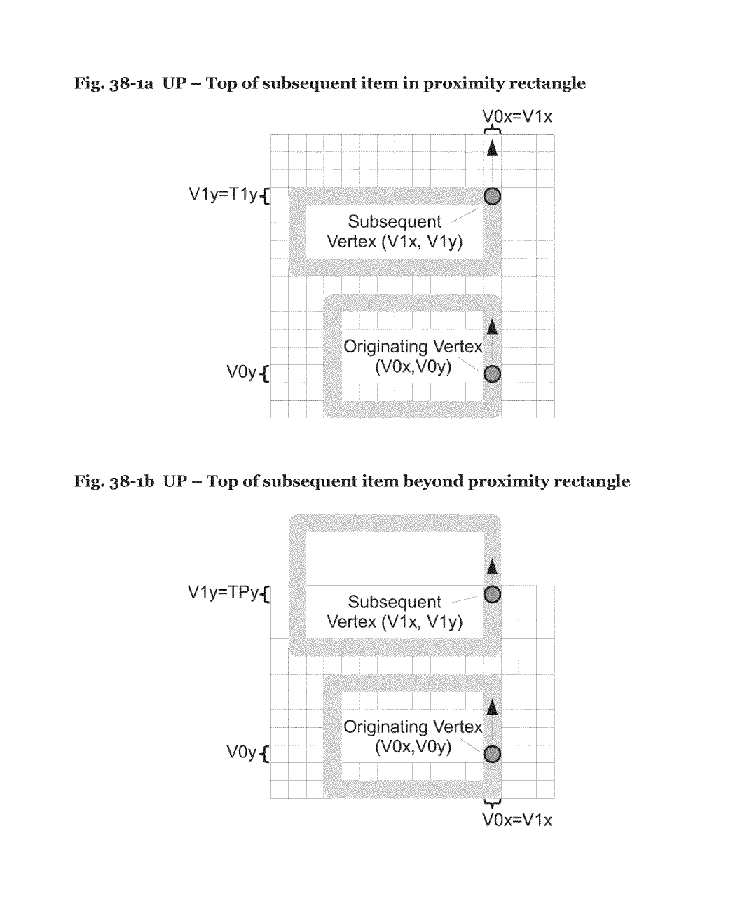

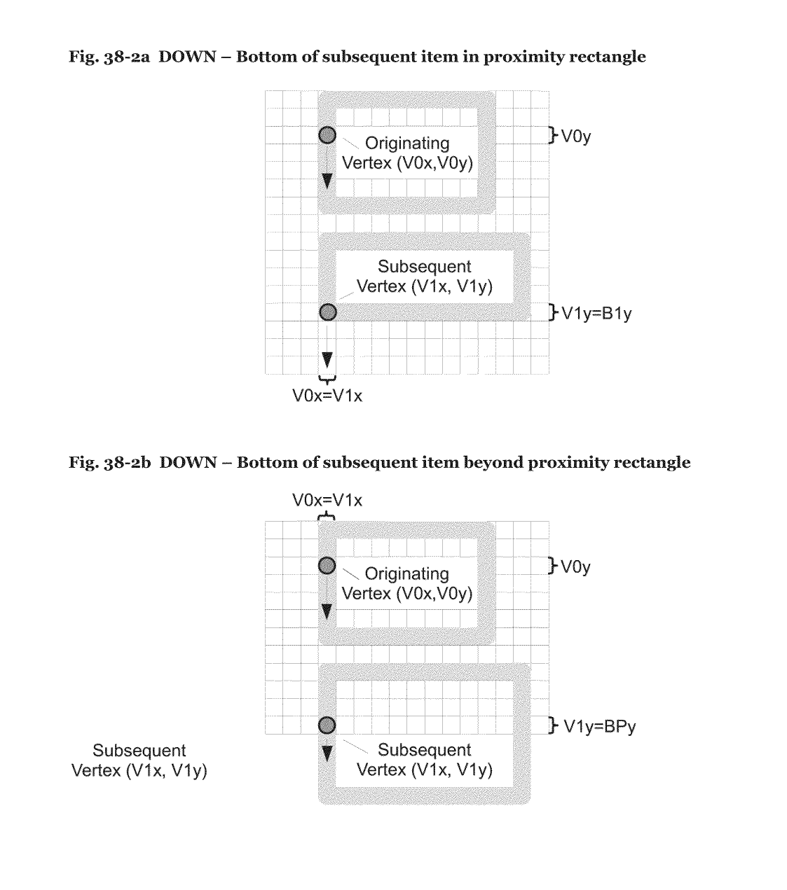

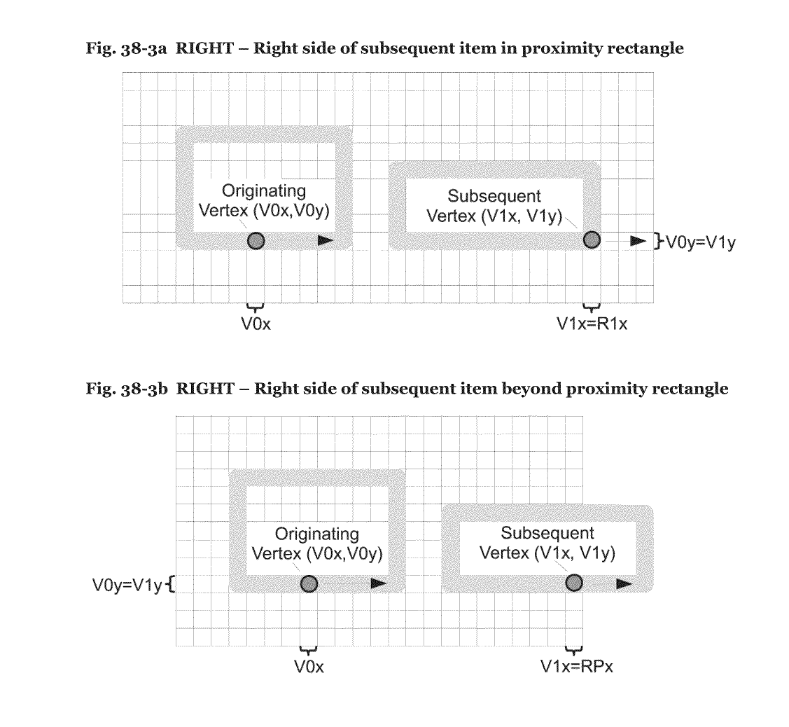

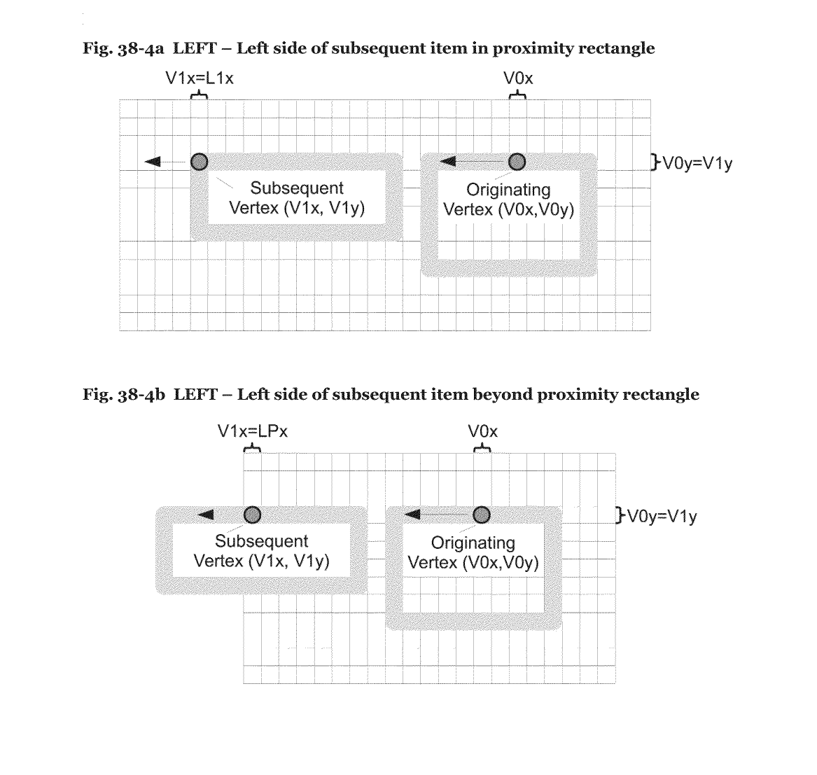

In FIGS. 38-1a and 38-1b, the direction of movement is upward (on the right side of each item). The X coordinates of both vertices (V0x, V1x) match. The Y coordinate of the subsequent vertex (V1y) is T1y (the top Y coordinate of the item of the subsequent vertex) in FIG. 38-1a, where it falls within the proximity rectangle, and TPy (the top Y coordinate of the proximity rectangle) in FIG. 38-1b, where the top of the item is beyond the proximity rectangle.

In FIGS. 38-2a and 38-2b, the direction of movement is downward (on the left side of each item). The X coordinates of both vertices (V0x, V1x) match. The Y coordinate of the subsequent vertex (V1y) is B1y (the bottom Y coordinate of the item of the subsequent vertex) in FIG. 38-2a, where it falls within the proximity rectangle, and BPy (the bottom Y coordinate of the proximity rectangle) in FIG. 38-2b, where the bottom of the item is beyond the proximity rectangle.

In FIGS. 38-3a and 38-3b, the direction of movement is right (at the bottom of each item). The Y coordinates of both vertices (V0y, V1y) match. The X coordinate of the subsequent vertex is R1x (the right X coordinate of the item of the subsequent vertex) in FIG. 38-3a, where it falls within the proximity rectangle, and RPx (the right X coordinate of the proximity rectangle) in FIG. 38-3b, where the right side of the item is beyond the proximity rectangle.

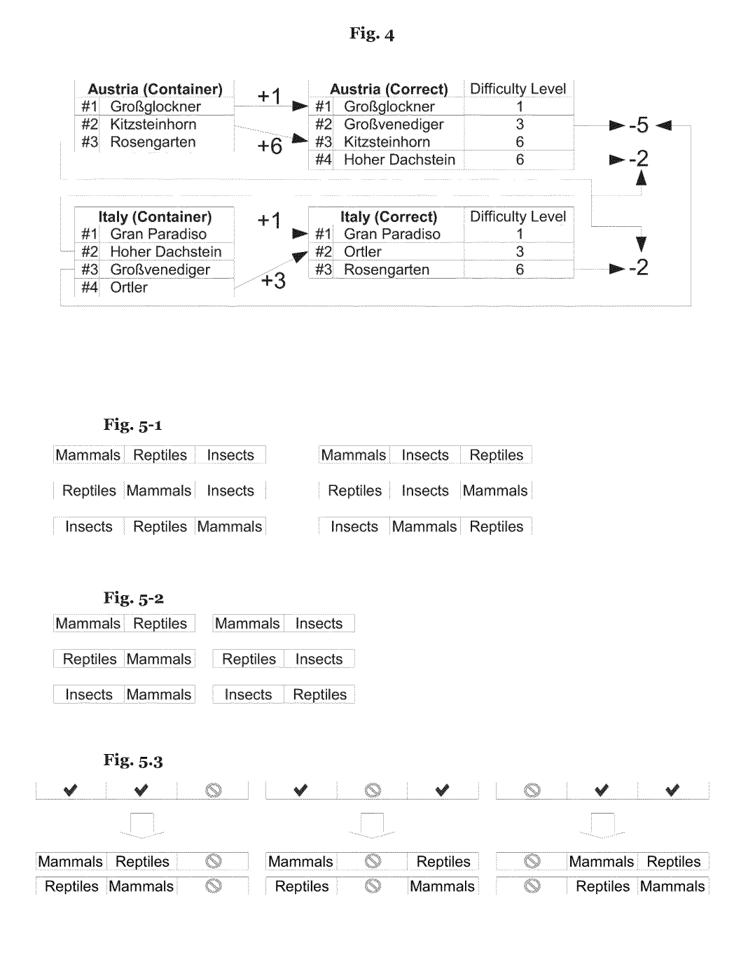

In FIGS. 38-4a and 38-4b, the direction of movement is left (at the top of each item). The Y coordinates of both vertices (V0y, V1y) match. The X coordinate of the subsequent vertex is L1x (the left X coordinate of the item of the subsequent vertex) in FIG. 38-4a, where it falls within the proximity rectangle, and LPx (the left X coordinate of the proximity rectangle) in FIG. 38-4b, where the left side of the item is beyond the proximity rectangle.

In the explanations below, the special case of the relevant part of the item of the subsequent vertex being beyond the proximity rectangle is not explained again, given that a person skilled in the art knows how to apply the same principles to the determination of vertex coordinates in other scenarios.

### Building Subsequent Vertices II: Inward Movement to the Least Inward Item

FIGS. 39-1, 39-2, 39-3 and 39-4 show, each in an exemplary subset of a proximity rectangle with exemplary items and vertices, the determination of the coordinates of the subsequent vertices in a scenario in which an inward movement cannot be avoided and the destination is the least inward item.

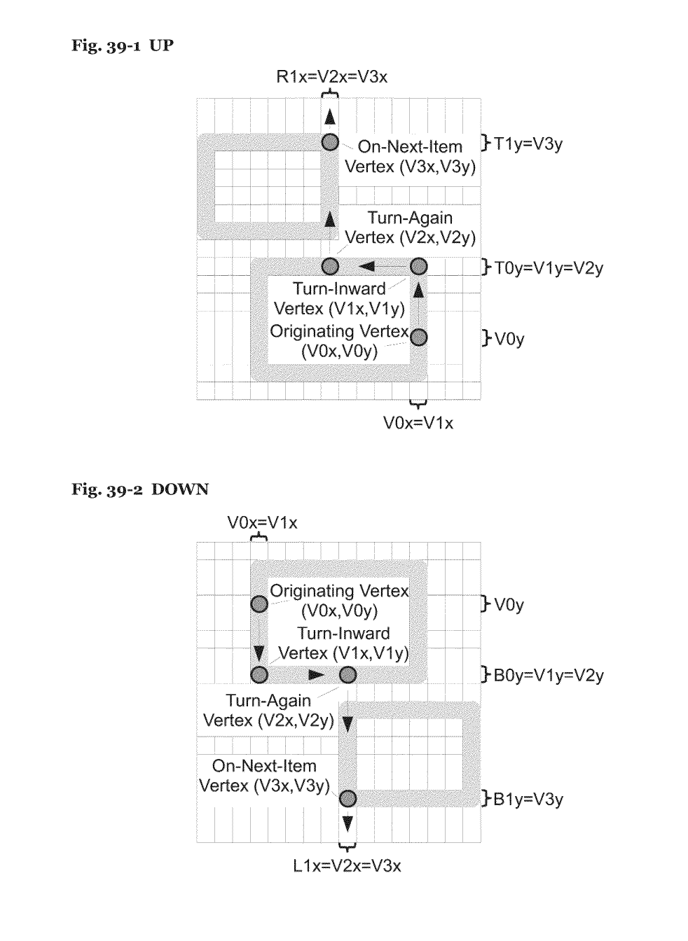

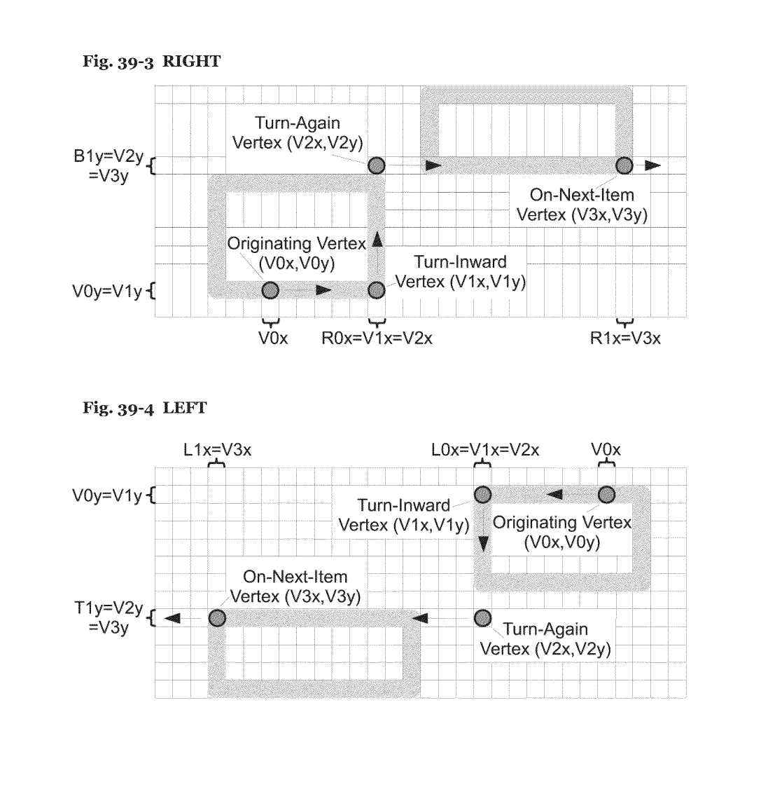

In FIG. 39-1, the direction of movement is up (on the right side of each item). The final destination is the on-next-item vertex V3 (coordinates: V3x, V3y), the top right corner of the next item (R1x is the right X coordinate of the next item, T1y is the top Y coordinate of the next item). In order to reach V3, two intermediate vertices are created. The next vertex is a turn-inward vertex V1 at the top right corner of the item of the originating vertex. Its X coordinate (V1x) matches that of the originating vertex (V0x). Its Y coordinate (V1y) is T0y, i.e., the top Y coordinate of the item of the originating vertex. Thereafter, a turn-again vertex V2 is created. Its X coordinate (V2x) is R1x, i.e., the right X coordinate of the next item, and matches that of the on-next-item vertex V3. Its Y coordinate (V2y) matches that of the turn-inward vertex.

In FIG. 39-2, the direction of movement is down (on the left side of each item). The final destination is the on-next-item vertex V3 (coordinates: V3x, V3y), the bottom left corner of the next item (L1x is the left X coordinate of the next item, B1y is the bottom Y coordinate of the next item). In order to reach V3, two intermediate vertices are created. The next vertex is a turn-inward vertex V1 at the bottom left corner of the item of the originating vertex. Its X coordinate (V1x) matches that of the originating vertex (V0x). Its Y coordinate (V1y) is B0y, i.e., the bottom Y coordinate of the item of the originating vertex. Thereafter, a turn-again vertex V2 is created. Its X coordinate (V2x) is L1x, i.e., the left X coordinate of the next item, and matches that of the on-next-item vertex V3. Its X coordinate (V2x) is L1x, i.e., the left X coordinate of the next item, and matches that of the on-next-item vertex V3. Its Y coordinate (V2y) matches that of the turn-inward vertex.

In FIG. 39-3, the direction of movement is right (at the bottom of each item). The final destination is the on-next-item vertex V3 (coordinates: V3x, V3y), the bottom right corner of the next item (R1x is the right X coordinate of the next item, B1y is the bottom Y coordinate of the next item). In order to reach V3, two intermediate vertices are created. The next vertex is a turn-inward vertex V1 at the bottom right corner of the item of the originating vertex. Its Y coordinate (V1y) matches that of the originating vertex (V0y). Its X coordinate (V1x) is R0x, i.e., the right X coordinate of the item of the originating vertex. Thereafter, a turn-again vertex V2 is created. Its X coordinate (V2x) is R1x, i.e., the right X coordinate of the next item, and matches that of the on-next-item vertex V3. Its Y coordinate (V2y) is B1y, i.e., the bottom Y coordinate of the next item, and matches that of the on-next-item vertex V3. In this example, the turn-again vertex V2 is outside of both items, due to the relative location of the two items.

In FIG. 39-4, the direction of movement is left (at the top of each item). The final destination is the on-next-item vertex V3 (coordinates: V3x, V3y), the top left corner of the next item (L1x is the let X coordinate of the next item, T1y is the top Y coordinate of the next item). In order to reach V3, two intermediate vertices are created. The next vertex is a turn-inward vertex V1 at the top left corner of the item of the originating vertex. Its Y coordinate (V1y) matches that of the originating vertex (V0y). Its X coordinate (V1x) is L0x, i.e., the left X coordinate of the item of the originating vertex. Thereafter, a turn-again vertex V2 is created. Its X coordinate (V2x) is L1x, i.e., the left X coordinate of the next item, and matches that of the on-next-item vertex V3. Its Y coordinate (V2y) is T1y, i.e., the top Y coordinate of the next item, and matches that of the on-next-item vertex V3. In this example, the turn-again vertex V2 is outside of both items, due to the relative location of the two items.

A person skilled in the art knows how to alternatively make diagonal connections from a turn-inward vertex to an on-next-item vertex if so desired. A person skilled in the art furthermore knows how to optionally convert the originating vertex into a turn-inward vertex if those two vertices would otherwise share the same coordinates. This applies, mutatis mutandis, to other vertex-building operations described in this specification.

### Building Subsequent Vertices III: Turning Inward in Absence of Inward and Outward Item

FIGS. 40-1, 40-2, 40-3 and 40-4 show, each in an exemplary subset of a proximity rectangle with one exemplary item and three exemplary vertices each, the determination of the coordinates of the subsequent vertices in a scenario in which an inward movement occurs on the same item because no inward or outward item has been identified in the direction of movement.

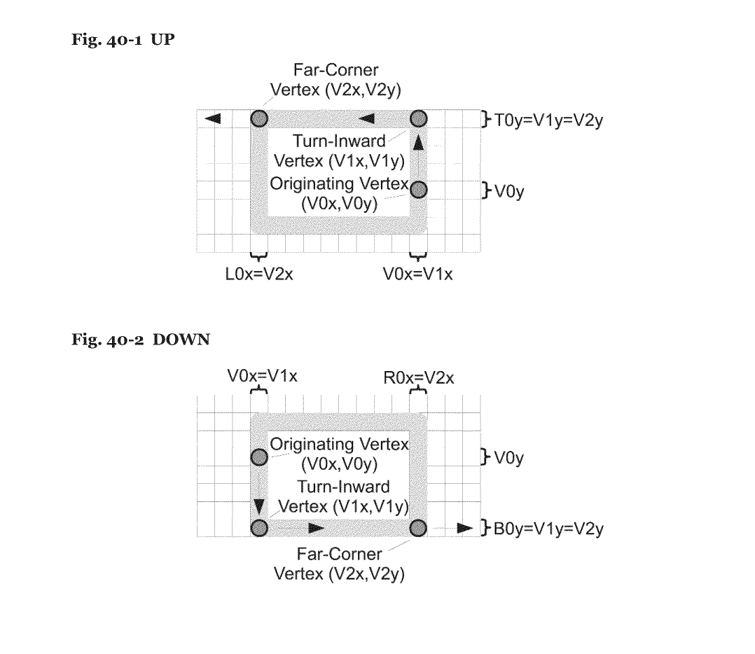

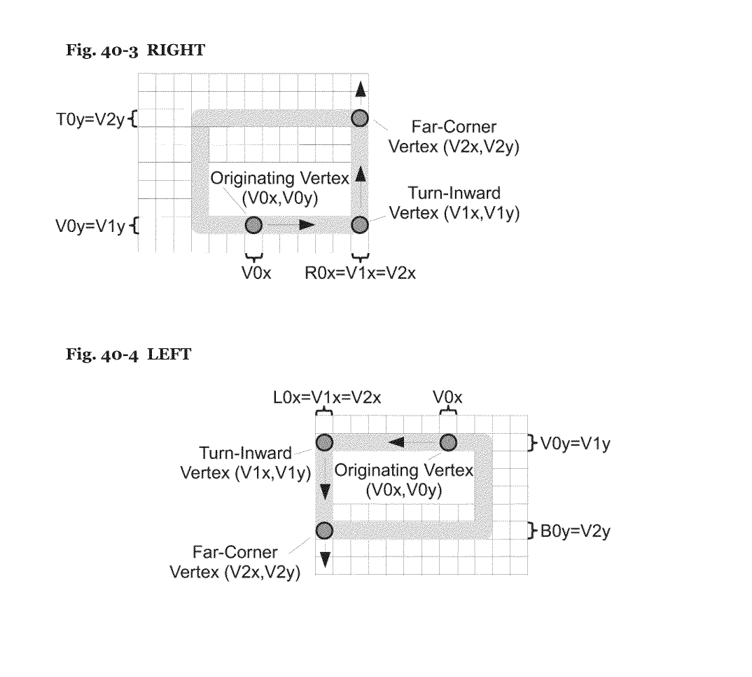

In FIG. 40-1, the direction of movement is upward (on the right side of each item). The final destination is the far-corner vertex V2 (coordinates: V2x, V2y), the top left corner of the item (L0x is the left X coordinate of the item, T0y is the top Y coordinate of the item). In order to reach V2, an intermediate vertex is created. The next vertex is a turn-inward vertex V1 at the top right corner of the item. Its X coordinate (V1x) matches that of the originating vertex (V0x). Its Y coordinate (V1y) is T0y, i.e., the top Y coordinate of the item.

In FIG. 40-2, the direction of movement is downward (on the left side of each item). The final destination is the far-corner vertex V2 (coordinates: V2x, V2y), the bottom right corner of the item (R0x is the right X coordinate of the item, B0y is the bottom Y coordinate of the item). In order to reach V2, an intermediate vertex is created. The next vertex is a turn-inward vertex V1 at the bottom left corner of the item. Its X coordinate (V1x) matches that of the originating vertex (V0x). Its Y coordinate (V1y) is B0y, i.e., the bottom Y coordinate of the item.

In FIG. 40-3, the direction of movement is right (at the bottom of each item). The final destination is the far-corner vertex V2 (coordinates: V2x, V2y), the top right corner of the item (R0x is the right X coordinate of the item, T0y is the top Y coordinate of the item). In order to reach V2, an intermediate vertex is created. The next vertex is a turn-inward vertex V1 at the bottom right corner of the item. Its Y coordinate (V1y) matches that of the originating vertex (V0y). Its X coordinate (V1x) is R0x, i.e., the right X coordinate of the item.

In FIG. 40-4, the direction of movement is left (at the top of each item). The final destination is the far-corner vertex V2 (coordinates: V2x, V2y), the bottom left corner of the item (L0x is the left X coordinate of the item, B0y is the bottom Y coordinate of the item). In order to reach V2, an intermediate vertex is created. The next vertex is a turn-inward vertex V1 at the top right corner of the item. Its Y coordinate (V1y) matches that of the originating vertex (V0y). Its X coordinate (V1x) is L0x, i.e., the left X coordinate of the item.

### Building Subsequent Vertices IV: Turning Outward to Closest Outward Item

FIGS. 4i-i, 4i-2, 4i-3 and 4i-4 show, each in an exemplary subset of a proximity rectangle with exemplary items and vertices, the determination of the coordinates of the subsequent vertices in a scenario in which an outward movement is made to the closest outward item.

In FIG. 4i-i, the direction of movement is up (on the right side of each item). The final destination is the further-out vertex V2 (coordinates: V2x, V2y), the bottom right corner of the next item (R1x is the right X coordinate of the next item, B1y is the bottom Y coordinate of the next item). In order to reach V2, an intermediate vertex is created. The next vertex is a turn-outward vertex V1. Its X coordinate (V1x) matches that of the originating vertex (V0x). Its Y coordinate (V1y) is B1y, i.e., the bottom Y coordinate of the item of the next vertex.

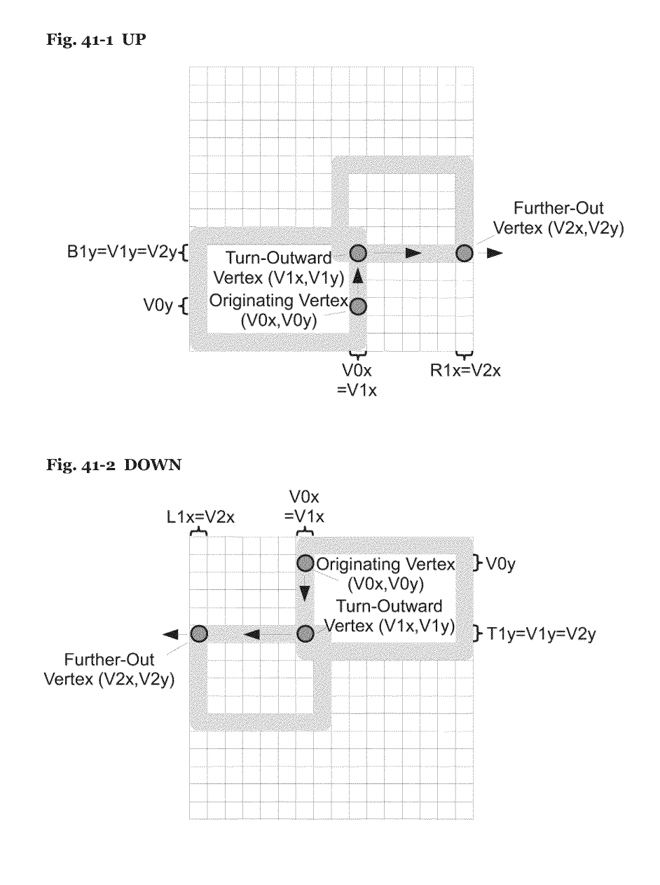

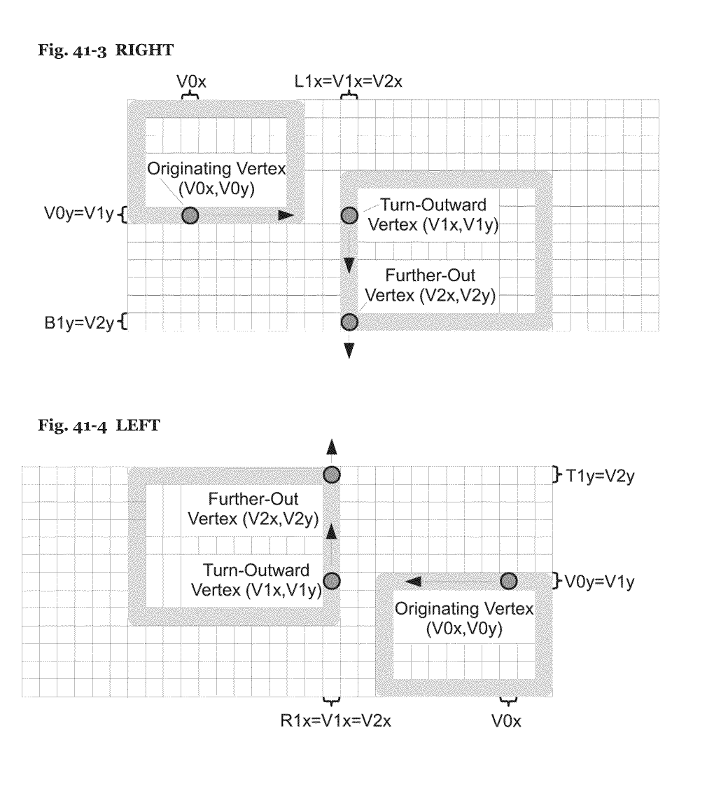

In FIG. 41-2, the direction of movement is down (on the left side of each item). The final destination is the further-out vertex V2 (coordinates: V2x, V2y), the top left corner of the next item (L1x is the let X coordinate of the next item, T1y is the top Y coordinate of the next item). In order to reach V2, an intermediate vertex is created. The next vertex is a turn-outward vertex V1. Its X coordinate (V1x) matches that of the originating vertex (V0x). Its Y coordinate (V1y) is T1y, i.e., the top Y coordinate of the item of the next vertex.

In FIG. 41-3, the direction of movement is right (at the bottom of each item). The final destination is the further-out vertex V2 (coordinates: V2x, V2y), the bottom left corner of the next item (L1x is the left X coordinate of the next item, B1y is the bottom Y coordinate of the next item). In order to reach V2, an intermediate vertex is created. The next vertex is a turn-outward vertex V1. Its Y coordinate (V1y) matches that of the originating vertex (V0y). Its X coordinate (V1x) is B1y, i.e., the bottom Y coordinate of the item of the next vertex.

In FIG. 41-4, the direction of movement is left (at the top of each item). The final destination is the further-out vertex V2 (coordinates: V2x, V2y), the top right corner of the next item (R1x is the right X coordinate of the next item, T1y is the top Y coordinate of the next item). In order to reach V2, an intermediate vertex is created. The next vertex is a turn-outward vertex V1. Its Y coordinate (V1y) matches that of the originating vertex (V0y). Its X coordinate (V1x) is T1y, i.e., the top Y coordinate of the item of the next vertex.

### Building Subsequent Vertices V: Turning Outward to Non-Closest Most Outward Item

FIGS. 42-1, 42-2, 42-3 and 42-4 show, each in an exemplary subset of a proximity rectangle with exemplary items and vertices, the determination of the coordinates of the subsequent vertices in a scenario in which an outward movement is made to the most outward item, which in this case cannot be presumed to be the closest (in terms of closest in the direction of movement) outward item.

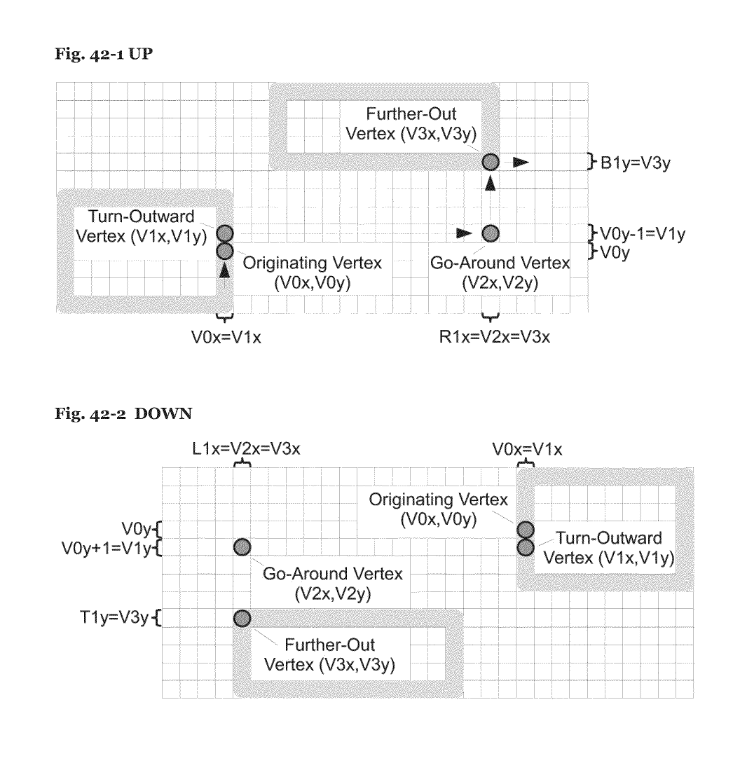

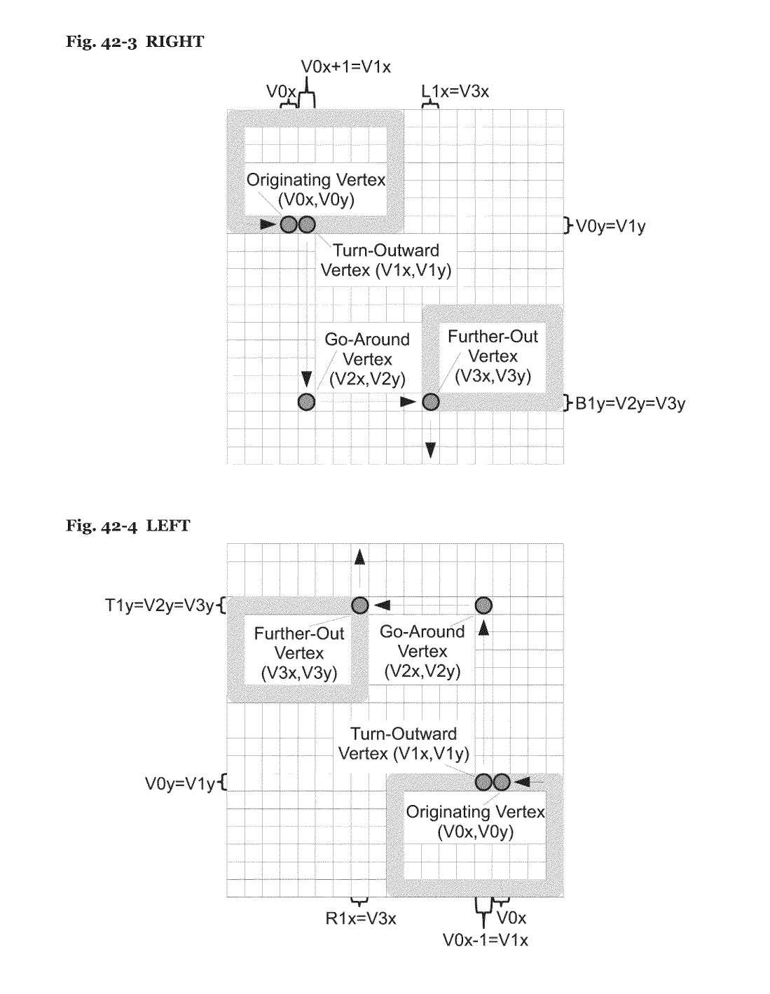

In FIG. 42-1, the direction of movement is up (on the right side of each item). The final destination is the further-out vertex V3 (coordinates: V3x, V3y), the bottom right corner of the next item (R1x is the right X coordinate of the next item, B1y is the bottom Y coordinate of the next item). In order to reach V3, two intermediate vertices are created. The next vertex is a turn-outward vertex V1. Its X coordinate (V1x) matches that of the originating vertex (V0x). Its Y coordinate (V1y) is immediately above the originating vertex, i.e., V0y-1 (all coordinates throughout this specification are based on the standard coordinate system in computer graphics, where a lower Y coordinate in a Cartesian coordinates system is represented by a higher Y coordinate because the origin of the coordinate system in computer graphics (0; 0) is the top left corner, not the bottom left corner). Thereafter, a go-around vertex V2 is created outside the items. Its X coordinate (V2x) is R1x, i.e., the right X coordinate of the next item, and matches that of the further-out vertex V3. Its Y coordinate (V2y) matches that of the turn-outward vertex.

In FIG. 42-2, the direction of movement is down (on the left side of each item). The final destination is the further-out vertex V3 (coordinates: V3x, V3y), the top left corner of the next item (L1x is the left X coordinate of the next item, T1y is the top Y coordinate of the next item). In order to reach V3, two intermediate vertices are created. The next vertex is a turn-outward vertex V1. Its X coordinate (V1x) matches that of the originating vertex (V0x). Its Y coordinate (V1y) is immediately below the originating vertex, i.e., V0y+1 (all coordinates throughout this specification are based on the standard coordinate system in computer graphics, where a lower Y coordinate in a Cartesian coordinate system is represented by a higher Y coordinate because the origin of the coordinate system in computer graphics (0; 0) is the top left corner, not the bottom left corner). Thereafter, a go-around vertex V2 is created outside the items. Its X coordinate (V2x) is L1x, i.e., the left X coordinate of the next item, and matches that of the further-out vertex V3. Its Y coordinate (V2y) matches that of the turn-outward vertex.

In FIG. 42-3, the direction of movement is right (at the bottom of each item). The final destination is the further-out vertex V3 (coordinates: V3x, V3y), the bottom left corner of the next item (L1x is the left X coordinate of the next item, thy is the bottom Y coordinate of the next item). In order to reach V3, two intermediate vertices are created. The next vertex is a turn-outward vertex V1. Its Y coordinate (V1y) matches that of the originating vertex (V0y). Its X coordinate (V1x) is immediately right of the originating vertex, i.e., V0x+1. Thereafter, a go-around vertex V2 is created outside the items. Its X coordinate (V2x) matches that of the turn-outward vertex. Its Y coordinate (V2y) is B1y, i.e., the bottom Y coordinate of the next item, and matches that of the further-out vertex V3.

In FIG. 42-4, the direction of movement is left (at the top of each item). The final destination is the further-out vertex V3 (coordinates: V3x, V3y), the top right corner of the next item (R1x is the right X coordinate of the next item, T1y is the bottom Y coordinate of the next item). In order to reach V3, two intermediate vertices are created. The next vertex is a turn-outward vertex V1. Its Y coordinate (V1y) matches that of the originating vertex (V0y). Its X coordinate (V1x) is immediately left of the originating vertex, i.e., V0x−1. Thereafter, a go-around vertex V2 is created outside the items. Its X coordinate (V2x) matches that of the turn-outward vertex. Its Y coordinate (V2y) is T1y, i.e., the top Y coordinate of the next item, and matches that of the further-out vertex V3.

Alternatively to creating a turn-outward vertex one pixel away from the originating vertex, it would also be possible to create another vertex with the same coordinates as the originating vertex or to modify the originating vertex. The turn-outward vertex reduces the go-around area by one pixel in one dimension, which may or may not be worth the creation of such vertex.

### Subsequent Identification of Shortcuts

A hull-building operation that identifies one vertex after the other can already avoid or minimize inward straits with such methods as, without limitation, the ones described above (including but not limited to the search for the least inward item among all connected items or among all connected items in a close-range zone, and the search for the most outward item among all connected items or among all connected items in a close-range zone).

Additionally, it is possible to identify shortcuts between vertices (cutting out all vertices between two vertices, or replacing one or more in-between vertices with an alternative vertex) by an analysis focusing on the vertices identified. Such analysis can be performed continually as the hull vertices are built and added to a collection of vertices, or it can be performed after all vertices of a hull have been built.

One particularly recommended criterion for such optimization is a detour factor, i.e., the factor by which the aggregate length of all vertex-to-vertex lines between two vertices exceeds the length of the most direct connection that still allows the hull as a whole to enclose all items of the relevant group (as opposed to crossing items or visually separating one part of the group from the remainder of the group). By way of example and without limitation, a detour factor of 2.5 could be deemed to be the maximum acceptable detour, and wherever it is exceed, a shortcut (within the aforementioned criteria) would be chosen.

### Identifying Enclave Groups

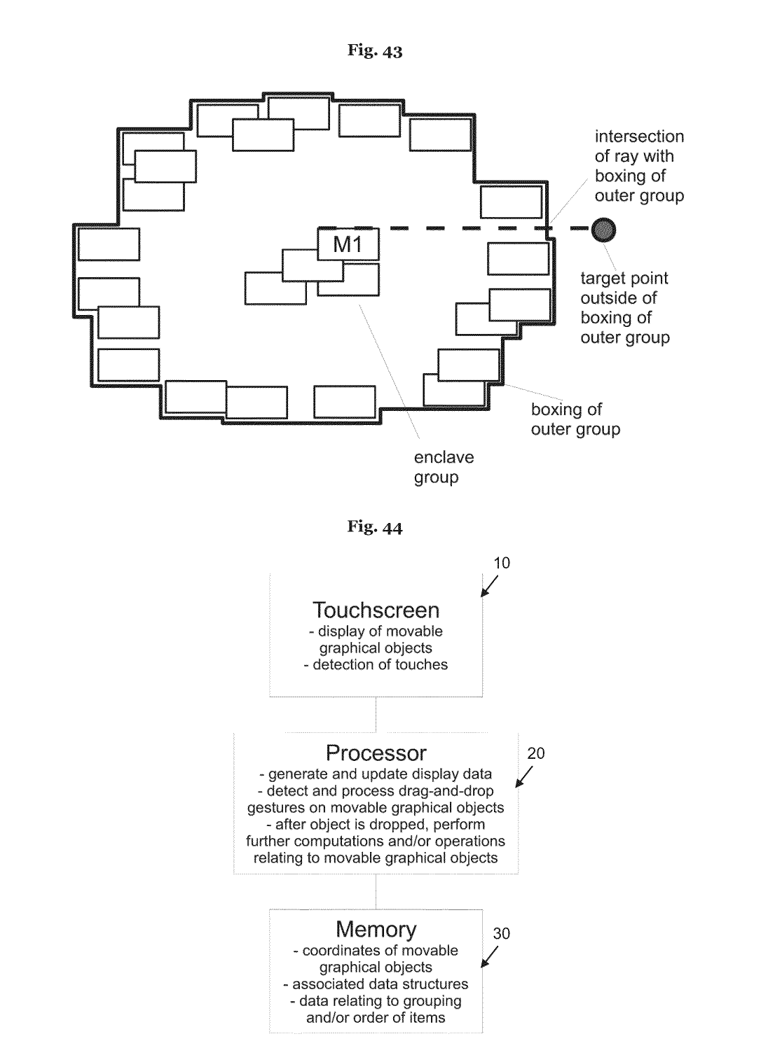

FIG. 43 shows an exemplary arrangement of items in which a dynamically-boxed group completely surrounds an enclave group, the four items in the middle, one of which is item M1. Without an identification of enclave groups, that group would also get a graphical hull. Depending on design goals, it may be preferable to avoid enclave groups.

In this case, and without limitation, a particularly efficient means of identifying an enclave group involves two steps. In the first (optional but recommended) step, the four extreme coordinates (top Y, bottom Y, right X, left X) of each group would be viewed as rectangles, and if the extreme rectangle of a first group is contained within the extreme rectangle of a second group, there is a possibility of the first group being an enclave group surrounded by the hull of the second group, in which case the second step is performed. The second step is a determination of whether any of the coordinates of the items of the first group is within the hull polygon of the second group. By way of example and without limitation, a very efficient method of determining that a point is contained within a polygon is called ray casting. A line between the point to be analyzed and an arbitrary target point outside of the polygon is defined (it need not, and usually will not, be displayed). That line, which is called a ray, is the dashed line in FIG. 43. The number of intersections of that ray with the polygon (in this case, the graphical hull of the second group; it could also be the actual hull) is counted. If there is an odd number of intersections, such as in this case, where the number is 1, the point is contained within the polygon. Otherwise there would be an even number of intersections.

Intersections with the (actual or graphical) hull can be determined most efficiently if all lines of the relevant hull are orthogonal. In the example, the connection with the target point outside the hull is a horizontal line, enabling the search to focus on all vertical lines (provided that all hull lines are orthogonal).

Even if a non-orthogonal hull is chosen for visual reasons, it may be efficient to build, even if used for few other purposes or no other purpose at all, a completely orthogonal hull with a view to subsequent ray casting.

### Actions Performed on and Evaluations of Dynamically-Boxed Groups

A dynamically-boxed group of items (regardless of the specifics of the visual aspects of the boxing or even in the absence of any visual hull) is a collection of movable graphical objects, each of which is associated with a data structure. Examples of associated data structures include, by way of example and without limitation, text strings, numbers, images, audio segments, video clips, files, databases, data sets of databases, data sets such as postal addresses and user records, URLs, HTML pages, and XML objects.

In any field of use, actions might be performed on the movable graphical objects belonging to a given group. By way of example and without limitation, all members of a group could be repositioned simultaneously with a single user interface gesture, or could be resized simultaneously, or their relative positions could be reorganized (for example, overlaps could be resolved by means of repositioning of items).

In certain fields of use such as (without limitation) knowledge quantification, the primary purpose of dynamic boxing is to enable the user to define and submit item groups, so as to evaluate the associated data structures upon submission (by way of example and without limitation, by comparing the grouping against a predefined set of correct item groups, and/or by comparing the order of one or more groups against a predefined correct order or set of correct orders).

Evaluations of the associated data structures could alternatively occur without requiring explicit submission. By way of example and without limitation, the aggregate size of all files associated with a group of movable graphical objects could be calculated and displayed.

In certain fields of use such as (without limitation) file management, the primary purpose of dynamic boxing is to enable the user to define item groups in order to trigger actions that will be performed on them. By way of example and without limitation, a group of files could be copied to a different storage medium or deleted.

### Clipping

Processing time can be saved by using known clipping techniques in order to refresh some or all aspects of the dynamic boxings (the composition of groups and/or the coordinates of an actual or graphical hull) only in those areas of the work space(s) affected by the latest repositioning. By way of example and without limitation, the four extreme coordinates (top Y, bottom Y, right X, left X) of each group would be viewed as rectangles, and if a repositioning of an item occurs entirely outside the extreme coordinates of a given group, and also at a distance based on which it can be ruled out that the repositioning affects the composition of that group and/or its actual or graphical hull, then that particular group need not be updated.

Clipping can also be based on multiple rectangles per group. By way of example and without limitation, a group that has a shape substantially resembling the letter L may be represented as two rectangles.

Non-rectangular shapes are also possible. By way of example and without limitation, clipping areas could be triangular. If a group has a shape substantially resembling the letter L, a triangle would be only approximately half as large as a rectangle.

Polygonal clipping is also possible and particularly efficient if a polygon consists of orthogonal lines. The above-mentioned ray casting method would allow quick determination of whether a given point (whereby more than one point will usually have to be evaluated to assess the impact of a repositioning of an item) is contained within a polygon. If orthogonal lines are not an option, the polygon could be, by way of example and without limitation, triangulated to accelerate such analysis.

### Update Frequency

Depending on the user interface technology, any movement of an item may be reported in a granular form, i.e., an event reporting a movement may be generated for each pixel by which the position of the item changes, or at least for a substantial number of segments of a movement that is a single movement from the user's perspective. A high update frequency may be unacceptable and could in a worst-case scenario make the device appear unresponsive.

In such cases, it may be preferable not to update the composition of groups, or at least not their graphical hulls, every step of the way. By way of example and without limitation, if the previously-processed movement was less than a predefined number of pixels away from the one just reported and also occurred less than predefined number of milliseconds before the one just reported, processing may wait until one or more additional movements have been reported or a certain period of time has passed (which can be evaluated with, among other things, the help of a timer triggering an event upon expiration, or a background thread cyclically checking on whether any deferred updates are due).

### Threading

The suitable methods to optimize response times to user interface gestures also include threading. The thread on which user interface events such as the repositioning of an item are reported should generally not have to perform computations that require significant amounts of processing time and can be delegated to one or more background worker threads. In connection with dynamic boxing, it is preferable to ensure that the repositioning of an item is visualized without unnecessary delay, but the identification of the composition of dynamic groups or at least updates of their graphical hulls can be handled by a background worker thread. The background worker thread can abort one cycle if the foreground thread defines a new priority task (for example, if the foreground thread reports another movement and requests its immediate processing).

When a foreground thread communicates to a background worker thread that it should analyze the composition of dynamic groups and/or update their graphical hulls, it should create and provide, or alternatively the background worker thread itself should in a first step create a copy of, the relevant the coordinates of all relevant items, given that a mere reference to the graphical objects themselves will become inconsistent if further repositioning occurs while the background thread is at work.

### Avoiding or Minimizing Overlaps

Dynamic boxing is a very natural way of grouping and/or ordering items, and the ability to place items in arbitrary positions maximizes the users' freedom. However, in some cases it may be desirable to resolve or reduce overlaps between items that occur as a result of users dropping an item in a position where it obscures one or more other items.

In response to the dropping of an item (with or without a predefined delay), or periodically, items could be repositioned automatically so as to avoid or minimize overlaps. It is preferable, however, to ensure that such repositionings do not change the composition of the dynamically-boxed groups. This can be ensured by limiting any such automatic repositionings to a display area that has a sufficient distance from any other item groups based on which it can be ruled out that any item would connect with items of any other group.

In computational geometry, algorithms are known to identify the maximal empty rectangle (see http://en(dot)wikipedia(dot)org/wiki/Largest_empty_rectangle). Such algorithms could be employed, possibly with adaptations, to identify a place within a dynamically-boxed group of movable graphical objects to which an otherwise-overlapping item could be moved. Such determinations could also be made by a background worker thread. However, if processing time represents a practical bottleneck, a compromise between geometric optimization and performance may have to be struck. By way of example and without limitation, a limited number of alternative positions for the item, preferably near the position chosen by the user, could be evaluated for overlaps, and the one with minimal overlaps would be chosen.

Automatic repositionings could also take into consideration where the user's attention likely is, either using sensors or based on the area of a screen in which the user's actions occur. By way of example and without limitation, if the user has not moved items in the lower half of a screen for a certain period of time, some automatic repositioning of one or more items in that area could be performed and such repositioning could have further-reaching impact than, for example, a repositioning occurring immediately in response to the dropping of an item.

### Simultaneous Repositioning of Multiple Items

Depending on the user interface technology used, the simultaneous repositioning of a plurality of items may be possible. The techniques described in this specification can all be applied to such simultaneous movements as well. By way of example and without limitation, in a mouse-and-keyboard environment the user may select multiple items by holding down the Shift key while clicking on every one of them, and then move those items simultaneously. By way of another example and without limitation, multitouch technologies may allow the user to move different items with different fingers, detecting touches relating to a plurality of items at the same time.

### Visual Representation Options

If the dynamic boxing of items is indicated visually to the user, different graphical options exist. In the following, some examples are discussed (without limitation).

A hull polygon can be drawn by drawing a line from each vertex with the next vertex and from the last vertex with the first vertex.

Instead of or in addition to polygon lines, the area of the hull polygon could be colored. Each group could be colored in a color of its own, or all groups could have the same background color as long as the color of a group is distinct from the background of the remainder of the work space(s).

Instead of or in addition to a hull polygon of any kind, the items belonging to a given group A could be colored in a color C, while the items of group B would be colored in color D. All groups consisting of small number of items may be colored in the same color if the assumption is that those small groups are only orphan items that the user has not (yet) assigned to a particular group. If two or more groups are combined, the combined group may receive a new color, or the color of one of the groups, with the color of the largest one of the previously-separate groups possibly being chosen as the color of the combined group.

Instead of or in addition to a common color, the movable graphical objects belonging to a given group could also be given a common shape and/or font.

Instead of or in addition to other methods, items belonging to the same group may be connected with lines that are drawn between them.

### Quantifying Knowledge of Item Relationships

The item relationships the present invention is primarily concerned with include
the membership of an item in a particular item group (for example, the fact that certain mountains are located in one country while certain other mountains are located in another country),
the order of a plurality of items by a given criterion (for example, the order of multiple political office-holders by the date of their initial appointment), and
combinations thereof (for example, the grouping of mountains by country combined with an ordering of the mountains in each country by elevation).

In most cases, item memberships in groups are single data points. For example, most rivers are located in only one country, and politicians can be members of only one political party at a given point in time. However, certain rivers (such as the Nile and the Rhine) are shared by a plurality of countries, and throughout an entire career, a politician may be a member of a plurality of parties (for example, Ronald Reagan was a member of the Democratic Party before joining the Republican Party in 1962). Similarly, one of the first 44 presidents of the United States, Grover Cleveland, served two non-consecutive terms and therefore constitutes the 22nd as well as the 24th president of the United States, while the other 43 presidents appear only once on a numbered list of presidents.

A person skilled in the art knows how to internally represent such relationships in different data formats. An item can be a member of a plurality of groups if each group constitutes a collection of items as long as there is no requirement that a data point of the item itself define one (and only one) group the item belongs to. Additionally or alternatively, each item may contain a collection of groups or group IDs in order to have room for multiple group memberships (or multiple ranks on an ordered list) per item.

On the display, items are represented by movable graphical objects. At least in scenarios in which no item is a member of more than one group or occurs more than once on an ordered list, it is a valid option that data structures may be associated with movable graphical objects by simply storing all of the data relating to the item itself (such as the name of a politician or mountain, with or without additional data) in the same object as the movable graphical object representing the item vis-à-vis the user. However, such arrangement of data would be inconsistent with the widely-adopted Model-View-Controller architectural pattern and would result in certain inefficiencies. For example, the lifecycles of data items and their corresponding graphical objects typically differ, suggesting that usually small data items should be kept separate from potentially memory-consuming graphical objects.

In certain preferred embodiments, each movable graphical object contains one data point linking a data item to the movable graphical object, typically (by way of example and without limitation) an item ID or a pointer to the location in which the item data is stored in memory.

A person skilled in the art implementing the invention can choose whether to implement movable graphical objects from scratch with known techniques or to make use of widely-available operating system functionality. Operating systems with graphical user interface layers typically provide controls (user interface elements) that detect some or all drag-and-drop actions by the user and can be repositioned by merely changing their coordinates before refreshing the display.

While embodiments of the invention can achieve the relatively highest level of performance if the movable and any non-movable graphical objects have a rectangular shape, the invention is not limited to any particular shape. For example, by using a transparent color, items may have a rectangular shape for internal purposes while appearing to the user to be arbitrarily-shaped. In this case, the invention delivers the same level of performance as in the case of visibly-rectangular shapes and is capable of performing the same optimization of any repositionings of items. Alternatively, arbitrary shapes can be supported by defining graphical objects as polygons. Algorithms for identifying intersections of items with polygons (including elliptic shapes, which are effectively polygons with large numbers of vertices) and locations of points relative to a polygon are known. Certain algorithms triangulate polygons, i.e., break polygons up into groups of triangles. Polygons can also be represented as groups of rectangles.

Relationships between items as well as between items and groups can be visually represented in different forms. It is common to place all (actual or presumed) members of an item group in a framed area, for example, a rectangular box, and to represent the order of items through the one-dimensional or two-dimensional positioning of such items relative to each other.

### Scoring Techniques

### Comparison of Grouping Input Against Correct Grouping

In order to quantify the user's knowledge of the group membership of items, it is necessary to compare the user's presumed composition of groups against a predefined correct grouping. FIG. 3 shows an example in which it is known that the user meant the first group (“Groβglockner”, “Kitzsteinhorn”, “Rosengarten”) to contain mountains located in Austria, the second group (“Zugspitze”, “Hochwanner”) to contain mountains located in Germany, and the third group (“Gran Paradiso”, “Hoher Dachstein”, “Groβvenediger”, “Ortler”) to contain mountains located in Italy.

This is undoubtedly the case if the user was asked to position certain groups in particular locations (for example, if the user was asked to group all Austrian mountains on the left side of the screen). Otherwise some further analysis of the user's intent, as explained below, may be required.

In FIG. 3, the comparison of the groups formed by the user against the correct groups shows that the user correctly identified both German mountains and correctly identified two Austrian as well as two Italian mountains, but erroneously deemed an Italian mountain (“Rosengarten”) to be an Austrian mountain and assigned two Austrian mountains (“Hoher Dachstein”, “Groβvenediger”) to Italy.

A strictly binary and coarse determination would result in a zero score because the user failed to correctly group all items.

Some alternative evaluations according to embodiments of the invention would count all correct assignments and award points for them; count all incorrect assignments and deduct points from a maximum achievable score; or award points based on the number by which the number of correct assignments exceeds the number of incorrect assignments.

FIG. 3 refers to three containers. For the purposes of evaluation of grouping input, the content of each dynamic boxing is equivalent to the content of a fixed container.

### Differentiated Scoring of Grouping Input

FIG. 4 shows an example of a more differentiated scoring of the same grouping input as in FIG. 3. The more differentiated scoring has an item-specific difficulty level. The difficulty level could also be the same for all items in a group. That difficulty level determines the number of points in which a correct assignment results (in the example, the number of points is identical to the difficulty level, but it could also be proportional to it or be read from a table of difficulty levels and points). In the example it also determines the number of points deducted for an incorrect assignment. In the example, the number of points deducted is greater if the difficulty level is higher: the incorrect assignment of “Hoher Dachstein” to Italy, instead of Austria, results in a deduction of only two points because the difficulty level was high (6), while the incorrect assignment of “Groβvenediger”, which has a lower difficulty level attached to it, is penalized with a deduction of five points. Again, the relationship could be numerical (for example, 8 minus the difficulty level) or the number of points to be deducted could be read from a table.) As stated above, scoring can be based on only correct assignments, on only incorrect assignments, or on a combination as in FIG. 4.

FIG. 4 refers to two containers. For the purposes of evaluation of grouping input, the content of each dynamic boxing is equivalent to the content of a fixed container.

### In-Between Positions of Items

It would be possible to allow intentionally-ambiguous placements. For example, the user might actually want to position an item corresponding to Mont Blanc in a place where it is close to the group of Swiss mountains and simultaneously (and similarly) close to the group of Italian mountains, given that Mont Blanc belongs to both countries and the ownership of its highest elevation is disputed. A single item technically forms its own dynamically-boxed group. For evaluation purposes it could be counted as a member of a plurality of groups between which (and similarly close to each of which) it is located. Also, there could also be two movable graphical objects relating to Mont Blanc, and the user could group one with Italian mountains and the other with Swiss mountains.

### Categorization of Item Groups

The groups of items formed by the user by means of dynamic boxing (such as the three groups in FIG. 1-2) are not labeled. If the correct group of items relating to a user-formed group is furthermore not defined by the location of the group, the knowledge quantification system needs to perform the intermediate step (between submission of an answer for evaluation and the actual scoring) of understanding the user's intended grouping by comparing the user-formed groups to the correct groups.

It is recommended to view the user's intended grouping in the light most favorable to the user. For example, if the user formed a first group consisting of three Austrian mountains and one Italian mountain and a second group consisting of two Italian mountains and one Austrian mountain, the user likely intended the first group to correspond to Austria and the second one to correspond to Italy.

Depending on the details of the scoring algorithm and on design decisions, an effort to view the user's input in the most favorable light may either involve a complete scoring of all permutations or a simpler evaluation, such as a count of correct assignments. Once a collection of permutations has been built, algorithms known to a person skilled in the art can evaluate each permutation and determine the permutation most favorable to the user. The most favorable permutation will then be the (sole) basis for scoring.

FIG. 5-1 shows the six possible permutations of three groups. If the user formed three groups, and there are three correct groups (in the example, “Mammals”, “Reptiles”, and “Insects”), any permutation could be the user's intended grouping.

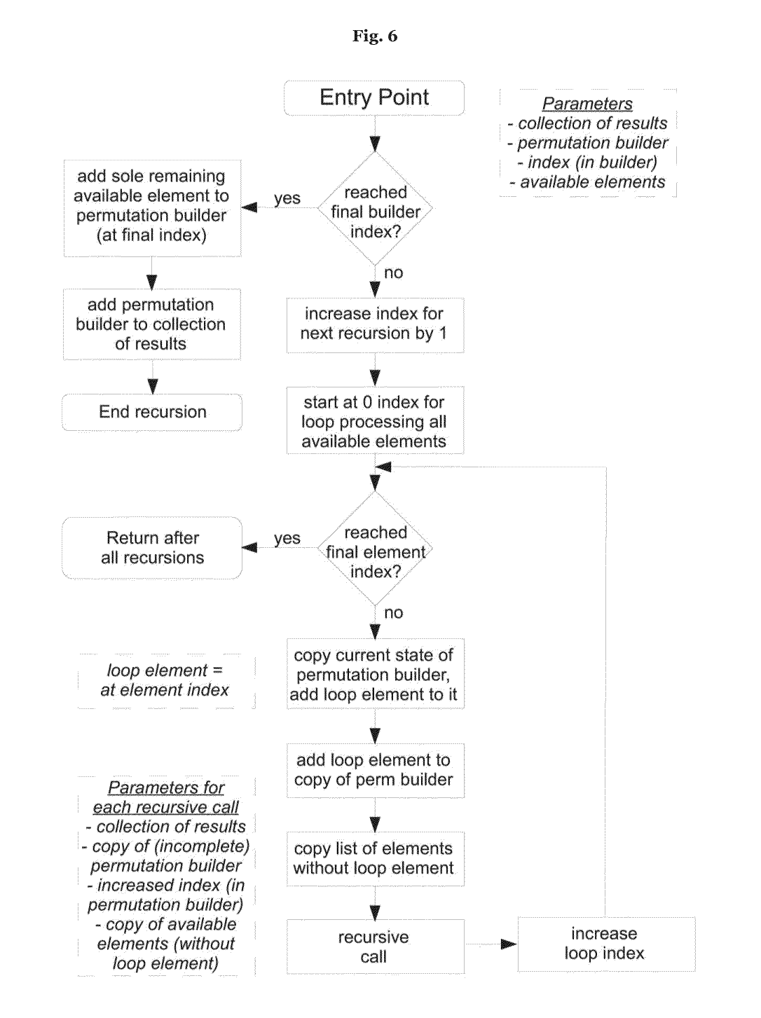

FIG. 6 is an exemplary flowchart of a recursive algorithm for generating a collection of all permutations in accordance with embodiments of the invention. The recursive function is called with four parameters: a collection of results (initially empty), a permutation builder (i.e., an object to which group IDs (alternatively, pointers to the groups) are added successively until a complete permutation has been built), an index within the builder (i.e., the zero-based index of where the next addition of an item to the permutation builder will occur), and a collection of available elements (i.e., group IDs available at this level of the recursive process for addition to the current permutation builder). Recursion ends when the final permutation builder index is reached, which is checked at the outset of the recursive function. In that event, there will be only one more available element (group ID) remaining, which is added to the current permutation builder, which in turn is added to the collection of results. No further recursive call is made at this juncture. If the final index has not been reached yet, a recursive call must be made for each of the available elements (group IDs). Inside the loop performing these calls, the current state of the permutation builder must be copied because further down the recursion path different additions will be made. For each recursive call, a copy of the list of available elements is provided after removing from that copy the element that was just added inside the loop.

Interpreting the user's intended grouping poses additional challenges if the number of user-formed groups differs from the correct number of groups.

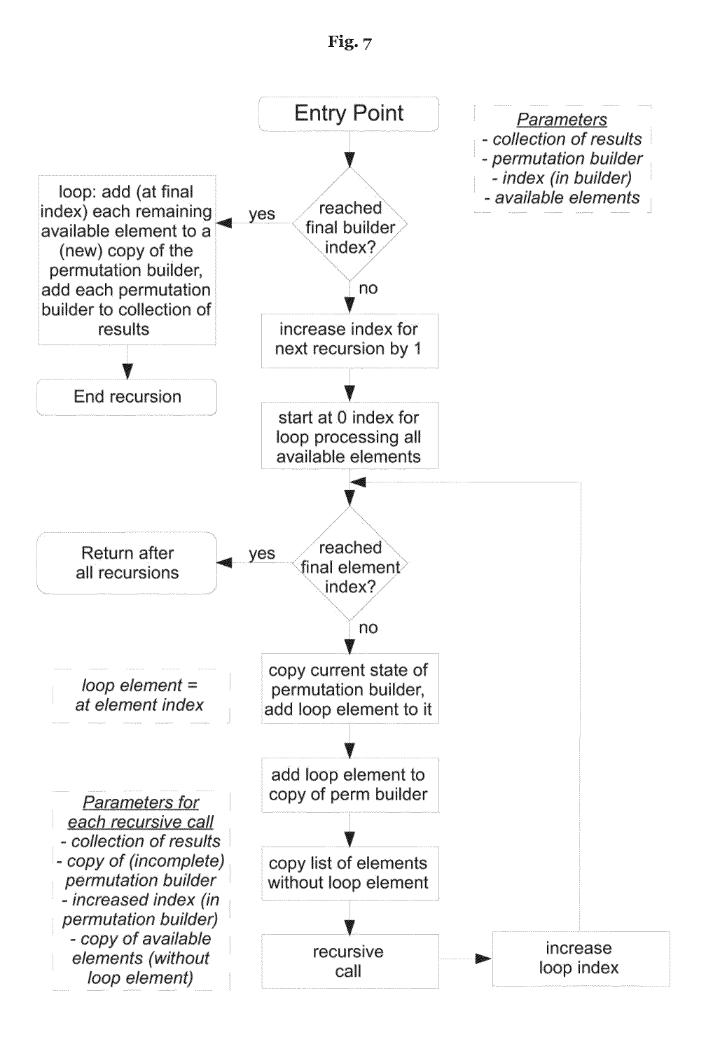

For a scenario in which the number of user-formed groups falls short of the correct number of groups, the permutations are limited to the number of user-formed groups as shown in FIG. 5-2. If the number of user-formed groups is one less than the number of correct groups, the number of permutations is identical to the number of permutations in the case of matching numbers of groups because the last slot would always be filled with the remaining element. If the number of user-formed groups is further below the number of actual groups, there is a difference in the number of permutations. FIG. 7 is an exemplary flowchart for generating permutations of item groups if the user-formed number of groups falls short of the correct number of groups. While there are certain similarities with FIG. 6, the operation at the end of the build process (i.e., when the final builder index, in this scenario determined by the number of user-formed groups, is reached) differs. A loop adds each remaining available element (i.e., group or group ID) to a (new) copy of the permutation builder, and then adds each builder to the collection of results. If the user had formed the correct number of groups, there would be no loop because only one item would remain in the collection at this stage.

If the user forms more groups than there are correct groups, one or more slots (corresponding to user-formed groups) will remain empty in the sense that those user-formed groups do not correspond to any correct group. FIG. 5-3 shows an exemplary set of permutations in which the user formed three groups while there are only two correct groups: Mammals and Reptiles. The prohibition sign indicates the empty slot. The empty slot can be in three different positions (first, second, and third). The total number of permutations is the number of insertion patterns (3 in the example) multiplied by the number of permutations of the correct number of groups (2 because the options are Mammals-Reptiles and Reptiles-Mammals).

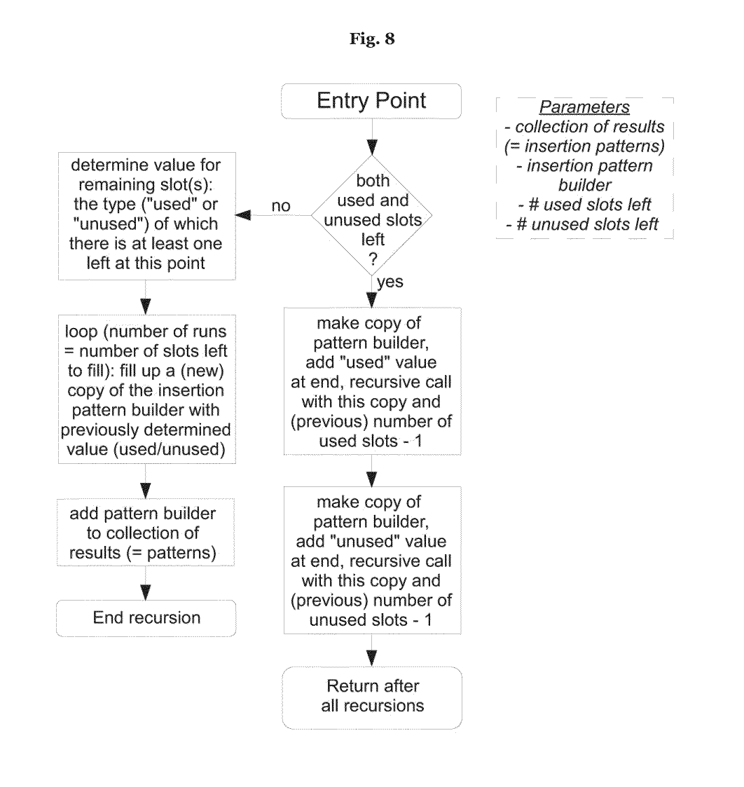

FIG. 8 is an exemplary flowchart for generating the insertion patterns, each of which must thereafter be filled with all permutations of correct item groups. The recursive function receives as parameters a collection of results (i.e., a collection of insertion patterns), an insertion pattern builder, the number of used slots left, and the number of unused slots left. While the collection of results and the insertion pattern builder grow, the numbers of used and unused slots left decrease due to recursion. If there is at least one used slot left and at least one unused slot left, two copies of the pattern builder are made, with the “used” value (i.e., there is a correct group corresponding to the user-formed group in this position) added to one and the “unused” value (i.e., there is no correct group corresponding to the user-formed group in this position) added to the other. Further recursive calls are mad, whereby the relevant number of slots is decreased. If there are one or more slots of only one kind left, a loop fills up copies of the insertion builder with the value (“used” or “unused”) for which there are one or more slots left, and recursion ends thereafter.

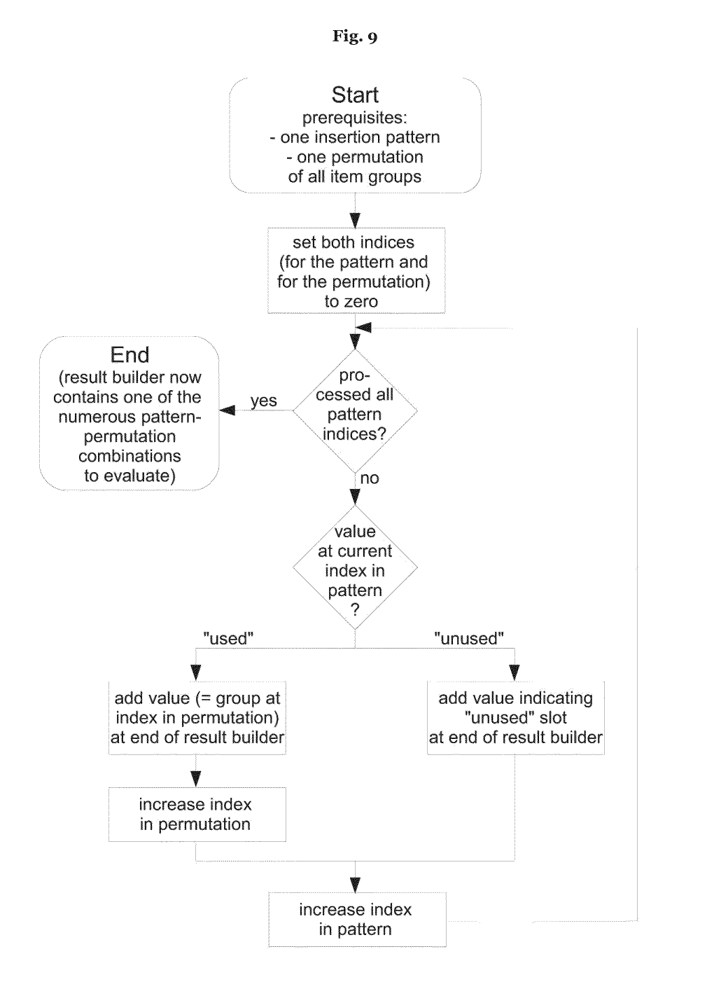

FIG. 9 is an exemplary flowchart for filling a given insertion pattern with a given permutation of item groups. The prerequisites are that there is one insertion pattern and one permutation of all correct item groups. This process needs to be performed for all combinations of insertion patterns with permutations of correct item groups. The loop combining one insertion pattern with one permutation needs two indices, one for the insertion pattern and one for the permutation, both of which are initially set to zero. If all indices of the insertion pattern have been processed, the process is complete and the content of the result builder is returned as the result. For each index of the insertion pattern it is necessary to distinguish between a “used” and an “unused” slot. If it is “used”, the value at the current index in the permutation builder is added to the result builder at its end, and the index within the permutation builder is increased before the loop continues with the next index in the insertion pattern. Otherwise a value indicating an “unused slot” (by way of example, and without limitation, this could be a negative value if no valid group has a negative group ID) is added to the result builder at its end before the loop continues with the next index in the insertion pattern.

A person skilled in the art knows how to modify the order of the operations shown on an exemplary basis in FIGS. 8 and 9. For example, it would be possible to firstly build all permutations of item groups, or to generate the final results in the same process (by determining the insertion options but immediately creating the final results).

### Comparison of Ordering Input Against Correct Order of Items

In a first step, the way in which the user arranged the movable graphical objects must be interpreted so as to identify the intended order (as discussed in Section 5.6). In a subsequent step, this ordering input must be compared against the correct order of the items.

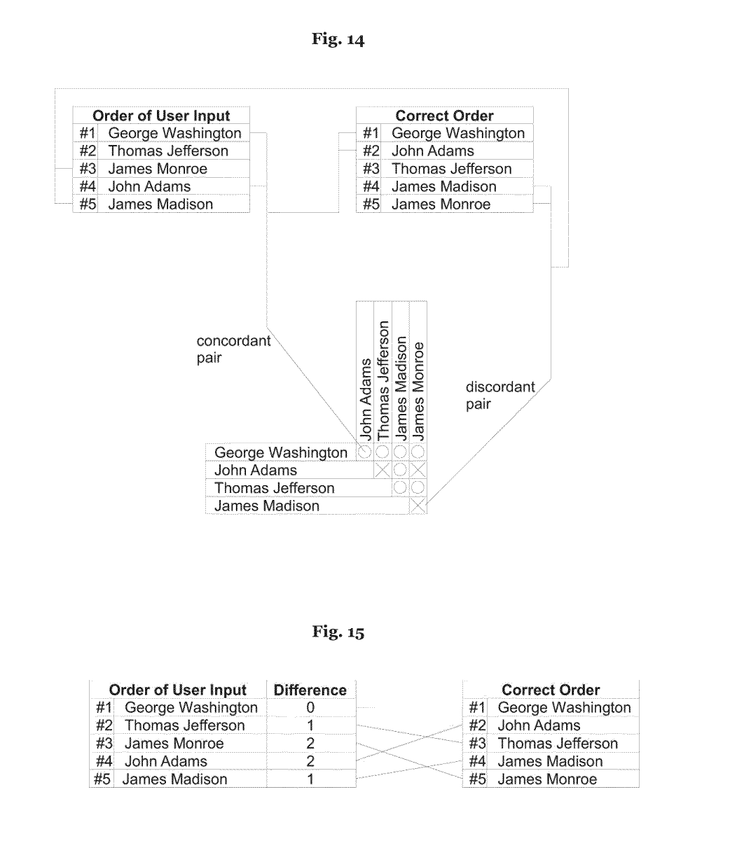

FIG. 14 shows an exemplary comparison of a user-determined order of items against the predefined correct order by means of computing the Kendall tau distance. In the example, the names of the first five presidents of the United States are ordered by the beginning of their first term. The Kendall tau distance is the number of discordant pairs, i.e., pairs of items that appear in the opposite order on one list as they do in the other. In the example, there are ten pairs in total. The total number of pairs of X number of items is always X(X−1)/2. In the example, seven of the pairs are concordant (the relative ranking of those items is identical on both lists) and three (John Adams-Thomas Jefferson; John Adams-James Monroe; and James Madison-James Monroe) are discordant. In absolute numbers, the Kendall tau distance in the example is 3. This absolute number can be normalized by dividing it by the total number of pairs, in which case 1 (or 100%) means that all pairs are discordant and 0 means that all pairs are concordant. In the example, the normalized Kendall tau distance amounts to 3/10=0.3 (or 30%). The knowledge quantification system can, for example, award a number of points that decreases with each discordant pair. It can also award points based on the difference between concordant and discordant pairs.

The following sample code written in the C# programming language for Microsoft Windows demonstrates (at the highest level) how to determine the Kendall tau distance:

```
private int GetKendallTauDistance( )
{
    int returnValue = 0;
    int highestCorrItemIndex = correctlyGroupedItems.Count − 1;
    for(int i = 0; i <= highestCorrItemIndex − 1; i++)
    {
      ItemWithIndexAndGroupId itemOuterLoop =
          correctlyGroupedItems[i];
      for (int j = i + 1; j <= highestCorrItemIndex; j++)
      {
          ItemWithIndexAndGroupId itemInnerLoop =
            correctlyGroupedItems[j];
          if (CheckIfDiscordantPair(itemOuterLoop,
            itemInnerLoop))
          {
            returnValue++;
          }
      }
    }
    return returnValue;
}
private Boolean CheckIfDiscordantPair(
    ItemWithIndexAndGroupId item1, ItemWithIndexAndGroupId item2)
{
    int userPosItem1 = GetUserPositionOfItem(item1);
    int userPosItem2 = GetUserPositionOfItem(item2);
    int corrPosItem1 = GetCorrPositionOfItem(item1);
    int corrPosItem2 = GetCorrPositionOfItem(item2);
    if (userPosItem1 < userPosItem2)
    {
      return (corrPosItem1 > corrPosItem2);
    }
    return (corrPosItem1 < corrPosItem2);
}
```

The GetKendallTauDistance function creates all pairs: every time the inner part of the inner loop is executed, the values of itemOuterLoop and itemInnerLoop represent one pair. The CheckIfDiscordantPair subroutine then retrieves the ranks (i.e., indices) of both items on the user-determined list (GetUserPositionOfItem) as well as on the predefined correct list (GetCorrPositionOfItem). If the first item appears on the user-determined list before the second item, the pair is found concordant if the opposite is the case on the correct model-answer list; otherwise it is a concordant pair and the result is “false”. Since two items on a list cannot have an identical rank, it is certain that if the first “if” condition in CheckIfDiscordantPair is not met, the first item appears after the second item on the user-determined list, in which case the pair is discordant if the first item appears before the second one on the model-answer list.

While the Kendall tau distance is the preferred measure for knowledge quantification relating to the order of a set of items, alternative algorithms are possible in embodiments of the invention. For example, a knowledge quantification system could focus its analysis on the ranks of one item at a time as opposed to pairs of items. FIG. 15 shows that, in the example, the first item (George Washington) has the correct rank, while the other four items have a false rank, with the difference between the correct and the user-determined rank being 1 each for Thomas Jefferson and James Madison, and 2 each for James Monroe and John Adams.

### Identification of User-Determined Order of Items in Non-Snapping Setup

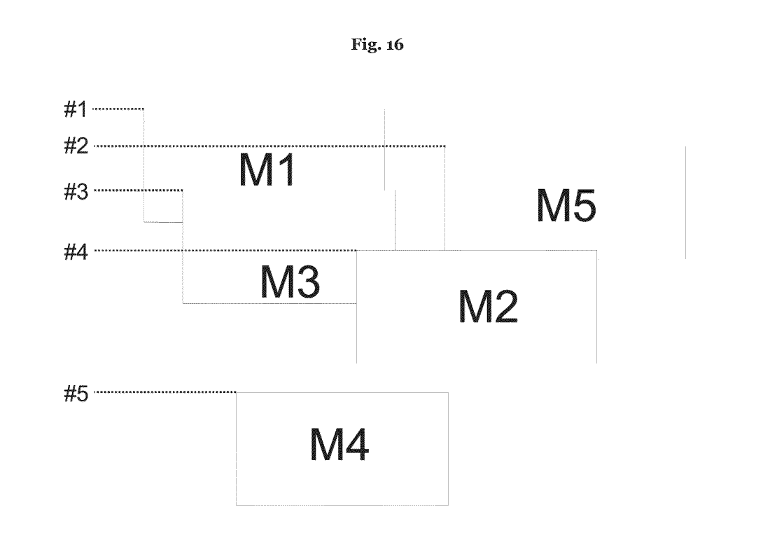

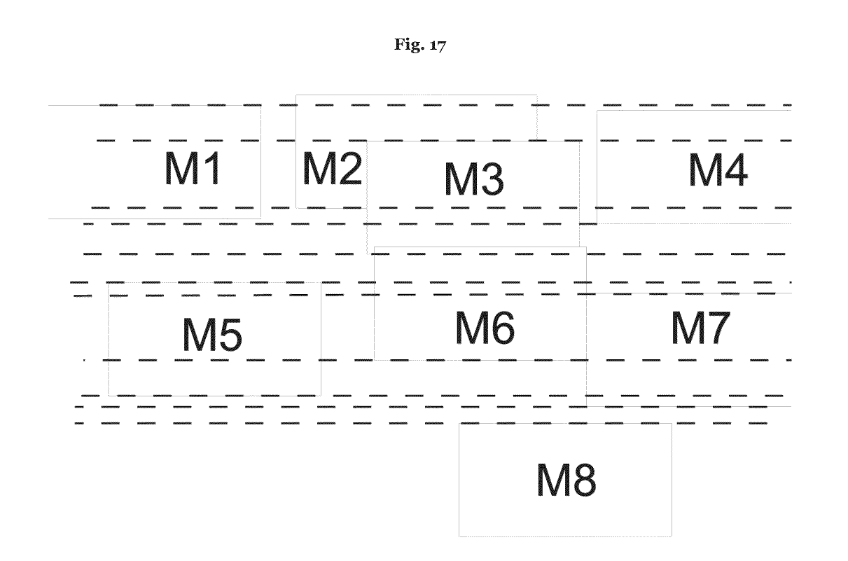

If a user is requested to order items one-dimensionally (i.e., vertically or horizontally), the user's intended order can be discerned based on the order of the relevant coordinate. FIG. 16 shows an exemplary identification of a vertical order of items based on the topmost Y coordinates of the items. In the example, each item has a unique top Y coordinate. If two or more items had the same topmost Y coordinate, their order relative to each other could either be determined based on a second criterion (for example, the X coordinate) or the user could be requested to provide clarity by repositioning items or otherwise indicating their intended order (for example, by touching or clicking on buttons representing answer to questions concerning ambiguities in the order of items).

On many displays, a two-dimensional ordering of items makes more efficient use of the available screen space. However, identification of a user-determined two-dimensional order of items based on arbitrarily-determined item positions requires, as a first step, the identification of rows. Thereafter, the relative position of items in a row can be determined in accordance with the above-described method of identifying a user-determined one-dimensional order by evaluating only the relevant coordinate (which for multiple items in a given row is the X coordinate).

FIG. 17 shows an exemplary arrangement of items (M1 to M8) whereby the dashed lines are the extended top and bottom lines of certain items. It is clear that the user intended items M1, M2, M3 and M4 to form the first row; items M5, M6 and M7 to form the second row; and M8 to be the only item in the third row. A programmable electronic device can discern these intended rows by beginning with the topmost item, which is M2 in the example and which is by definition a member of the first (topmost) row. The question is then which other items are in the same row as M2. M1 and M4 are particularly clear cases because their Y coordinate ranges (top to bottom) overlap for the largest part with that of M2. The Y coordinate range of M3 overlaps with that of M2 to a lesser degree, but still more than 50% of the Y coordinate range of M3 falls within that of M2, while the only item that has a Y coordinate range overlap with M3 besides those that are unambiguously in the first row (M1, M2, M4) is M6, which has only a marginal overlap of its Y coordinate range with that of M3 and no overlap whatsoever with any of the three items that are undoubtedly in the first row (M1, M2, M4). It is a recommended requirement that all items deemed to be in the same row have a significant Y range overlap with each other, as do M1, M2, M3 and M4 in the example. There is no single threshold value that must inevitably be applied, but the shared part of the Y coordinate ranges of all items in a row should typically amount to at least 40%, possibly 50% or more, of the Y coordinate range of each item in that row. In the example, that is also the case for M5, M6 and M7 (second row). M8 is clearly isolated and represents a row of its own.

It would be possible at submission time to request the user to disambiguate the arrangement of items by repositioning them or by answering questions (such as by touching or clicking on buttons representing answers).

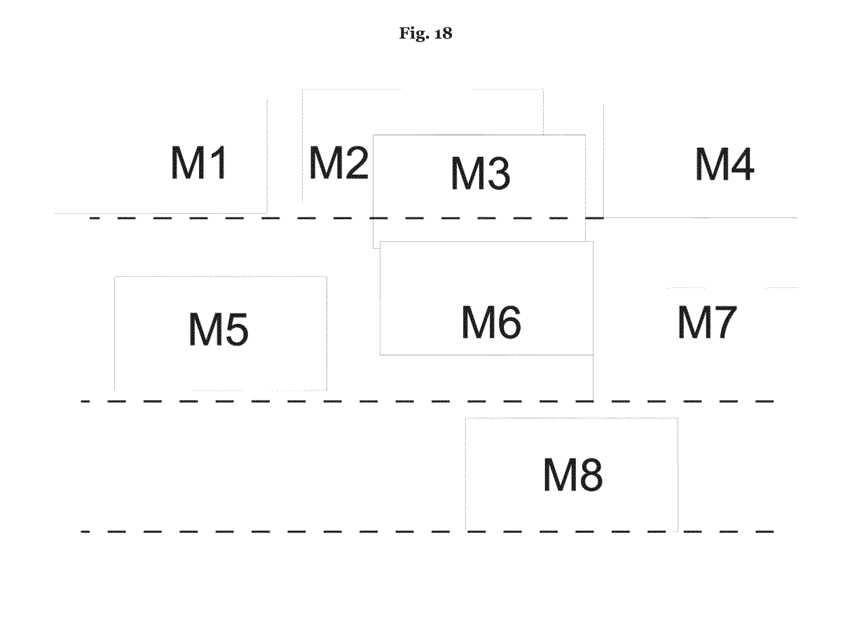

However, the preferred way to avoid ambiguities is to provide visual feedback to the user's arrangement of items so as to indicate the order of items as identified by the programmable electronic device at a given point in time. FIG. 18 shows an exemplary visualization (by means of dashed lines) of identified rows. In the example, the row to indicate the first (topmost) line (M1, M2, M3, and M4) is the (horizontally-extended) bottom line of M4, which has the lowest bottom line of those four items that does not touch any item from a lower line (in this case, M6). The (horizontally-extended) bottom line of M7 is the lowest bottom line of all items in the second row and at the same time the lowest one that does not touch any item from a lower line (in this case, M8).

Alternatively or additionally to lines drawn to indicate the rows identified by the programmable electronic device based on the user's arrangement of items, the items could also be numbered in the order identified. The identified rank of each item could be displayed on that item, next to that item, or partly overlap it.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, executed by at least one computer for processing drag-and-drop gestures on a user interface, the method comprising:
a. displaying a plurality of graphical objects on the user interface, at least two of said graphical objects each being associated with a data structure, at least two of said data structures being associated with a model answer of an automated knowledge quantification system;
b. detecting a drag-and-drop gesture on the user interface indicating that a first one of the plurality of graphical objects is moved relative to a second one of the plurality of graphical objects; and
c. dynamically determining that the first and second graphical objects belong to a common group of objects based on the proximity of the first to the second graphical object.

2. The method of claim 1, wherein step c. comprises determining the proximity of the first to the second graphical object by determining whether the second graphical object at least partially overlaps at least one proximity rectangle around the first graphical object.

3. The method of claim 1, wherein step c. is performed iteratively for each of the plurality of graphical objects.

4. The method of claim 2, wherein step c. is performed iteratively for each of the plurality of graphical objects.

5. The method of claim 1, wherein the step of dynamically determining that the first and second graphical objects belong to a common group of objects is based on a predefined required proximity of the first to the second graphical object.

6. The method of claim 1, wherein the step of dynamically determining that the first and second graphical objects belong to a common group of objects is based on a relative proximity of the first to the second graphical object compared to at least one third graphical object.

7. The method of claim 2, wherein the step of dynamically determining that the first and second graphical objects belong to a common group of objects is based on a relative proximity of the first to the second graphical object compared to at least one third graphical object.

8. The method of claim 3, wherein the step of dynamically determining that the first and second graphical objects belong to a common group of objects is based on a relative proximity of the first to the second graphical object compared to at least one third graphical object.

9. The method of claim 1, further comprising dynamically displaying a graphical indication of the common group of objects.

10. The method of claim 9, wherein the graphical indication of the common group of objects comprises a polygonal shape adapting dynamically to contours of the graphical objects belonging to the group.

11. The method of claim 9, wherein the graphical indication of the common group of objects is selected from a group consisting of: a convex hull, a concave hull and/or an alpha shape.

12. The method of claim 10, wherein the graphical indication of the common group of objects is selected from a group consisting of: a convex hull, a concave hull and/or an alpha shape.

13. The method of claim 9, comprising performing a two-dimensional normalization of all graphical objects belonging to a common group of objects.

14. The method of claim 9, wherein the graphical indication of the common group of objects is calculated by travelling from one vertex of the graphical objects belonging to the group to the next to determine a polygonal shape of the group.

15. The method of claim 1, wherein the user interface is displayed on a touch-sensitive display (10) of a portable electronic device.

16. A non-transitory computer-readable medium storing a computer program executable by a computer to perform instructions for implementing a method in accordance with claim 1.

17. A portable electronic device, comprising:
a. a touch-sensitive display;
b. display module configured for instructing the touch-sensitive display to present a plurality of graphical objects on a user interface, at least two of said graphical objects each being associated with a data structure, at least two of said data structures being associated with a model answer of an automated knowledge quantification system; and
c. at least one processor;
d. a module configured for executing on said at least one processor instructions for:
detecting a drag-and-drop gesture on the user interface indicating that a first one of the plurality of graphical objects is moved relative to a second one of the plurality of graphical objects; and
dynamically determining that the first and second graphical objects belong to a common group of objects based on the proximity of the first to the second graphical object.

18. The portable electronic device of claim 17, wherein the display module is further configured for instruct the touch-sensitive display to display dynamically a graphical indication of the common group of objects.

19. The portable electronic device of claim 18, wherein the graphical indication of the common group of objects comprises a polygonal shape adapting dynamically to contours of the graphical objects belonging to the group.
